(19) United States
(12) Patent Application Publication
(10) Pub. No.: US 2025/0353725 A1
(43) Pub. Date: Nov. 20, 2025

(54) DRINKING APPARATUS

(71) Applicants: FOSHAN SHUNDE MIDEA WATER DISPENSER MANUFACTURING CO., LTD., Foshan (CN); MIDEA GROUP CO., LTD., Foshan (CN)

(72) Inventors: Sipei HONG, Foshan (CN); Baoyou CHENG, Foshan (CN)

(73) Assignees: FOSHAN SHUNDE MIDEA WATER DISPENSER MANUFACTURING CO., LTD., Foshan (CN); MIDEA GROUP CO., LTD., Foshan (CN)

(21) Appl. No.: 18/999,802

(22) Filed: Dec. 23, 2024

Related U.S. Application Data
(63) Continuation of application No. PCT/CN2024/133610, filed on Nov. 21, 2024.

(30) Foreign Application Priority Data
May 15, 2024 (CN) 202410607554.1
May 15, 2024 (CN) 202410607585.7
May 15, 2024 (CN) 202410607722.7
May 15, 2024 (CN) 202421065369.6
May 15, 2024 (CN) 202421065405.9
May 15, 2024 (CN) 202421065423.7
May 15, 2024 (CN) 202421065473.5
May 15, 2024 (CN) 202421065536.7
May 15, 2024 (CN) 202421068390.1
May 15, 2024 (CN) 202421068401.6

(51) Int. Cl. B67D 1/00

(52) U.S. Cl. CPC B67D 1/0014; B67D 2210/00002; B67D 2210/00031

(57) ABSTRACT

Provided are a drinking apparatus including a water treatment device, a water inlet device, and a water outlet device. The water inlet device has a water source port, a water treatment port, a water outlet port, and a first flow passageway assembly. The first flow passageway assembly is configured to guide water from the water source to flow to the water treatment device and water outlet device. The water outlet device has a second flow passageway assembly, a first port, and a second port. One of the first port and the second port is configured to be connected to the water inlet device, and another one of the first port and the second port is configured to be connected to a water outlet component. The first port and the second port are in communication with each other via the second flow passageway assembly.

### CROSS-REFERENCE TO RELATED APPLICATIONS

This application is a continuation of International Application No. PCT/CN2024/133610, filed on Nov. 21, 2024, which is based on and claims priority to ten China Patent Applications Nos. 202421068401.6, 202421065423.7, 202410607554.1, 202421065405.9, 202421065536.7, 202421068390.1, 202421065473.5, 202421065369.6, 202410607585.7, 202410607722.7, all filed on May 15, 2024, the entire contents of each of which are incorporated herein by reference. No new matter has been introduced.

### FIELD

The present disclosure relates to the field of household appliance technologies, and more particularly, to a drinking apparatus.

### BACKGROUND

In the related art, a water dispenser employs a silicone pipeline to connect a cooling tank and a heating tank for water intake. However, the reliability is low, and quality problems such as tube breakage and water leakage are easy to occur. In addition, since an integration degree of the water dispenser is low, a factory operation can only be carried out through a manual assembly, which is unable to realize automation and modularization production and has low production efficiency.

### SUMMARY

A drinking apparatus according to embodiments of the present disclosure includes a water treatment device, a water inlet device, and a water outlet device. The water inlet device has a water source port, a water treatment port, a water outlet port, and a first flow passageway assembly. The water source port is configured to be connected to a water source. The water treatment port is configured to be connected to the water treatment device. The water outlet port is configured to be connected to a water outlet device. The water source port, the water treatment port, and the water outlet port are connected by the first flow passageway assembly. The first flow passageway assembly is configured to guide water from the water source to flow to the water treatment device and the water outlet device. The water outlet device has a second flow passageway assembly, a first port, and a second port. One of the first port and the second port is configured to be connected to the water inlet device, and another one of the first port and the second port is configured to be connected to a water outlet component. The first port and the second port are in communication with each other via the second flow passageway assembly.

Additional aspects and advantages of the present disclosure will be given at least in part in the following description, or become apparent at least in part from the following description, or can be learned from practicing of the present disclosure.

### BRIEF DESCRIPTION OF THE DRAWINGS

FIG. 1 is a schematic view of a water inlet device of a drinking apparatus according to an embodiment of the present disclosure.

FIG. 2 is another schematic view of the water inlet device shown in FIG. 1.

FIG. 3 is a schematic bottom view of the water inlet device shown in FIG. 2.

FIG. 4 is yet another schematic view of the water inlet device shown in FIG. 2.

FIG. 5 is a schematic assembly view of the water inlet device and a water outlet device shown in FIG. 1.

FIG. 6 is another schematic assembly view of the water inlet device and the water outlet device shown in FIG. 5.

FIG. 7 is a schematic exploded view of an assembly of the water inlet device and the water outlet device shown in FIG. 6.

FIG. 8 is a schematic assembling view of the water inlet device and a water treatment device shown in FIG. 1.

FIG. 9 is a schematic assembly view of the water inlet device, a water outlet device, and a water outlet component shown in FIG. 8.

FIG. 10 is a schematic mounting view of a water inlet device and a water treatment device of a drinking apparatus according to an embodiment of the present disclosure.

FIG. 11 is a schematic view of a heating tank component of a water treatment device according to an embodiment of the present disclosure.

FIG. 12 is a schematic view of a cooling tank component of a water treatment device according to an embodiment of the present disclosure.

FIG. 13 is a schematic sectional view of an assembly of the cooling tank component and a water inlet device shown in FIG. 12.

FIG. 14 is an enlarged view of part A shown in FIG. 13.

FIG. 15 is a schematic view of a first seal shown in FIG. 14.

FIG. 16 is an enlarged view of part B shown in FIG. 13.

FIG. 17 is a schematic view of a drinking apparatus according to an embodiment of the present disclosure.

FIG. 18 is a schematic assembling view of a water outlet component of the drinking apparatus shown in FIG. 17.

FIG. 19 is a schematic assembling view of a housing and the water outlet component shown in FIG. 18.

FIG. 20 is a schematic assembling view of a drinking apparatus according to another embodiment of the present disclosure.

FIG. 21 is a schematic view of the drinking apparatus shown in FIG. 20 according to another embodiment of the present disclosure.

FIG. 22 is a schematic sectional view of an assembly of a water outlet device and a water outlet component shown in FIG. 13.

FIG. 23 is a schematic view of a water outlet device shown in FIG. 20.

FIG. 24 is another schematic view of the water outlet device shown in FIG. 23.

FIG. 25 is a schematic exploded view of the water outlet device shown in FIG. 23.

FIG. 26 is a schematic view of a second seal shown in FIG. 25.

FIG. 27 is a schematic view of a second seal shown in FIG. 25.

FIG. 28 is a schematic view of a drainage device of a drinking apparatus according to an embodiment of the present disclosure.

FIG. 29 is another schematic view of the drainage device shown in FIG. 28.

FIG. 30 is a schematic assembling view of the drainage device shown in FIG. 28.

FIG. 31 is a schematic assembling view of the drainage device and a heat exchanger shown in FIG. 30.

FIG. 32 is a schematic view of a waterway system of a drinking apparatus according to an embodiment of the present disclosure.

FIG. 33 is a schematic view showing outflowing of room temperature water in the waterway system shown in FIG. 32.

FIG. 34 is a schematic view showing water inflowing and exhaust of a cooling tank component of the waterway system shown in FIG. 32.

FIG. 35 is a schematic view showing outflowing of hot water in the waterway system shown in FIG. 32.

FIG. 36 is a schematic view showing exhaust of a heating tank component of the waterway system shown in FIG. 32.

### REFERENCE NUMERALS

100, drinking apparatus;
1, water treatment device;
101, heating tank component; 1011, first engagement slot; 1012, first positioning hole; 1013, first ventilation port; 1014, first water port; 1015, second water port;
102, cooling tank component; 1021, second engagement slot; 1022, first positioning post; 1023, second ventilation port; 1024, third water port; 1025, fourth water port;
2, water inlet device;
201, inlet water manifold; 20101, second positioning post; 20102, third engagement protrusion; 20103, positioning portion; 20104, third positioning hole; 20105, positioning base;
202, room temperature water dispensing basin; 20201, water storage chamber; 20202, first buffer chamber; 20203, second buffer chamber; 20204, first partition; 20205, second partition; 20206, basin body;
203, first flow passageway; 20301, first inlet; 20302, first outlet;
204, second flow passageway; 20401, second outlet;
205, third flow passageway; 20501, third inlet; 20502, third outlet;
206, first exhaust tube; 20601, first exhaust vent; 20602, first air inlet;
207, avoidance hole;
208, second exhaust tube; 20801, second air inlet; 20802, second exhaust vent;
209, fourth flow passageway; 20901, fourth inlet; 20902, fourth outlet;
2010, fifth flow passageway; 201001, fifth inlet; 201002, fifth outlet;
2011, sixth flow passageway; 201101, sixth inlet; 201102, sixth outlet;
2012, second plate portion; 2013, first connection tube;
3, water outlet device; 301, water outlet connection tube; 3011, first port; 3012, second port;
302, first plate portion; 3021, water outlet positioning hole; 3022, engagement slot;
303, countersunk structure; 304, surrounding panel; 305, reinforcing rib;
306, fixing cover; 3061, first sleeve; 3062, second sleeve; 3063, engagement hook; 3064, first avoidance notch; 3065, second avoidance notch;
307, housing-connected positioning post;
4, first seal; 401, first sealing portion; 402, second sealing portion; 403, first sealing groove;
5, second seal; 501, third sealing portion; 502, fourth sealing portion; 503, second sealing groove;
6, third seal; 601, fifth sealing portion; 602, sixth sealing portion; 603, third sealing groove;
8, water outlet component; 801, valve body; 802, second connection tube; 803, third port;
804, room temperature water outlet member; 805, hot water outlet member; 806, cold water outlet member;
9, drainage device; 901, second main body;
902, drainage flow channel; 9021 first drainage port; 9022 second drainage port;
903, plate body portion; 904, first drainage positioning hole;
905, first tubular body; 9051, first tube section; 9052, second tube section;
906, second tubular body; 9061, third tube section; 9062, fourth tube section;
907, blocking element; 908, drainage avoidance hole;
909, first positioning structure; 9010, second positioning structure;
10, heat exchanger; 11, compressor;
13, housing; 1301, limit hole; 1302, fixing plate; 1303, mounting hole;
14, water pump; 15, intelligent seat;
1000, waterway system;
1001, water source; 1002, main water inlet flow passageway;
1003, first exhaust passage; 1004, second exhaust passage;
1005, a first drainage flow passageway; 1006, a second drainage flow passageway.

### DETAILED DESCRIPTION OF THE EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

A number of embodiments or examples are provided in the disclosure of the present disclosure to implement different structures of the present disclosure. To simplify the disclosure of the present disclosure, components and arrangements of particular examples will be described below, which are examples only and are not intended to limit the present disclosure. Furthermore, reference numerals and/or reference letters may be repeated in different examples of the present disclosure. Such repetition is for the purpose of simplicity and clarity and does not indicate any relationship between various embodiments and/or arrangements in question. In addition, various examples of specific processes and materials are provided in the present disclosure. However, those of ordinary skill in the art may be aware of applications of other processes and/or the use of other materials.

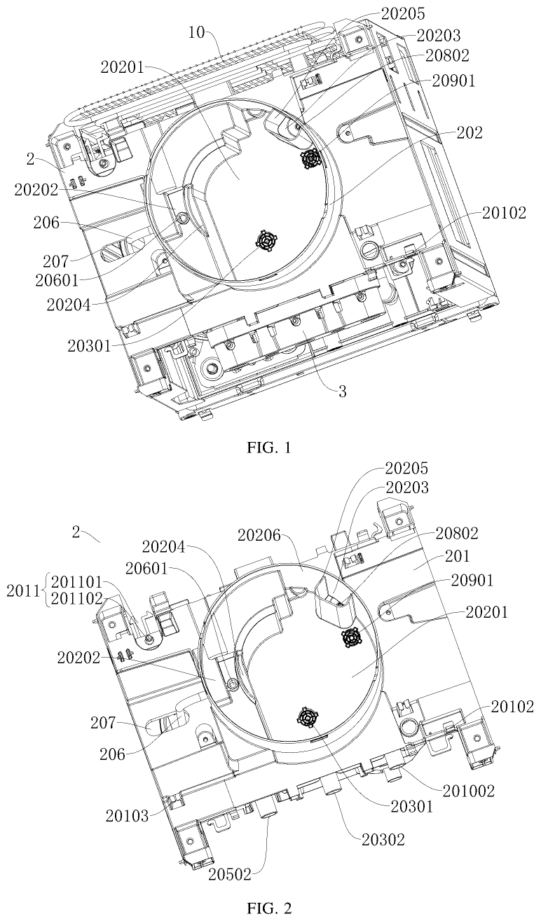

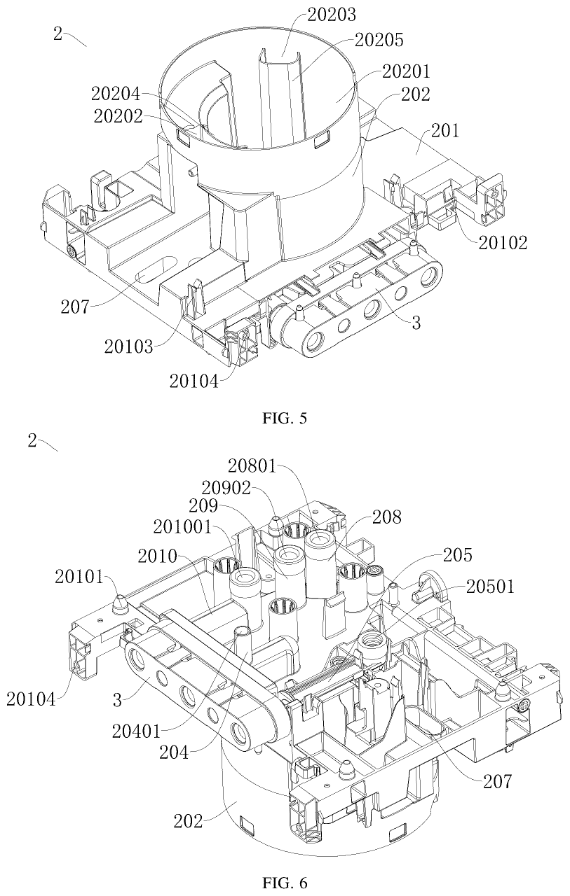

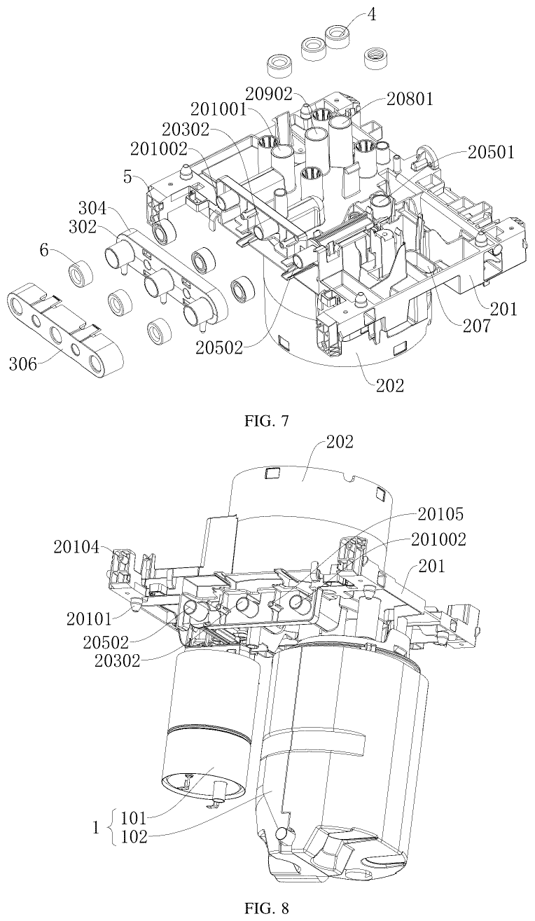

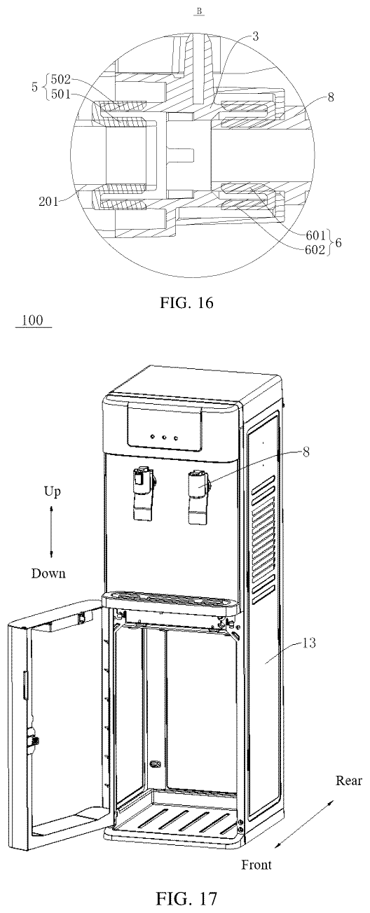

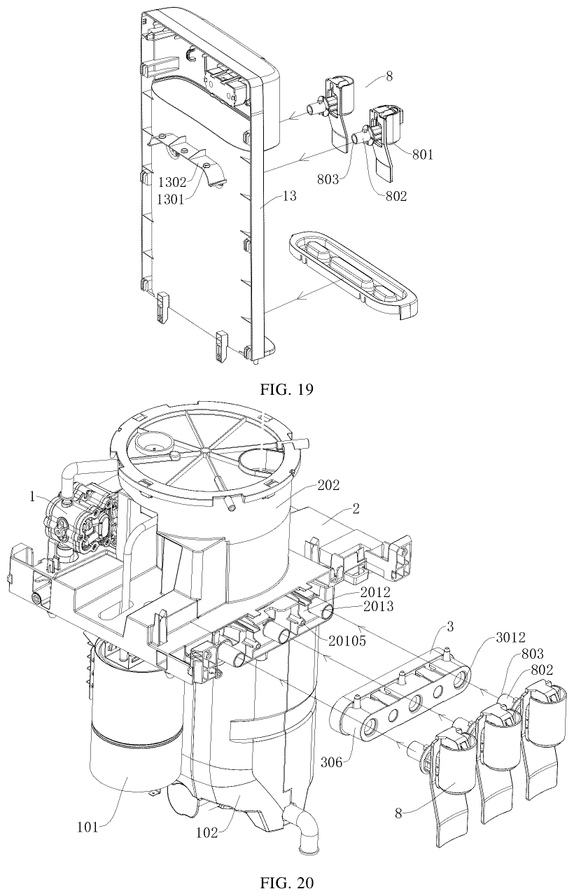

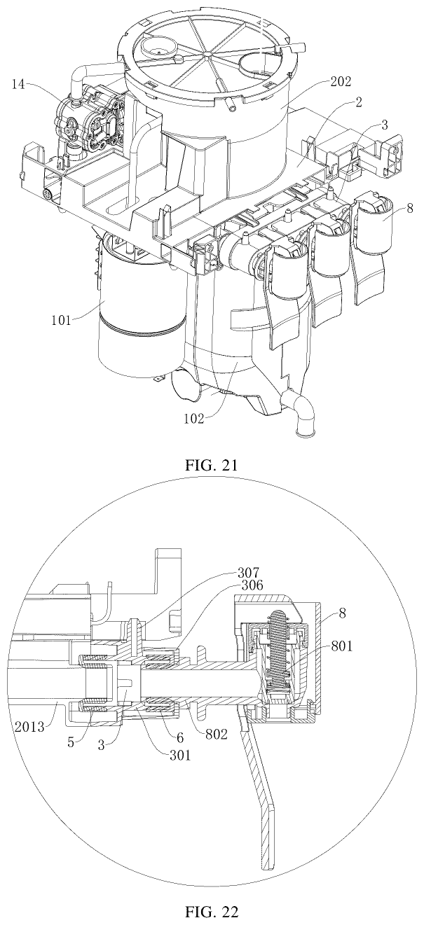

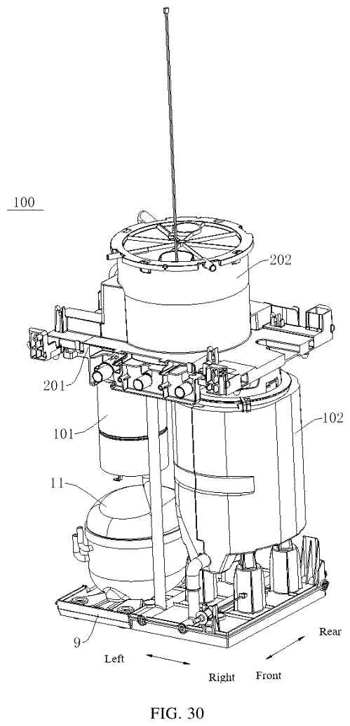

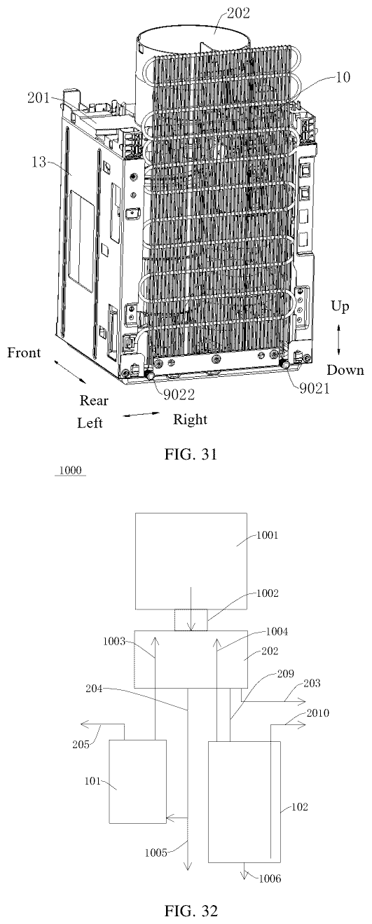

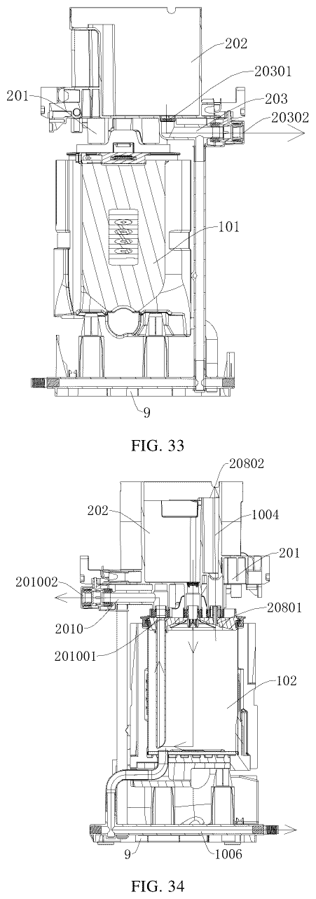

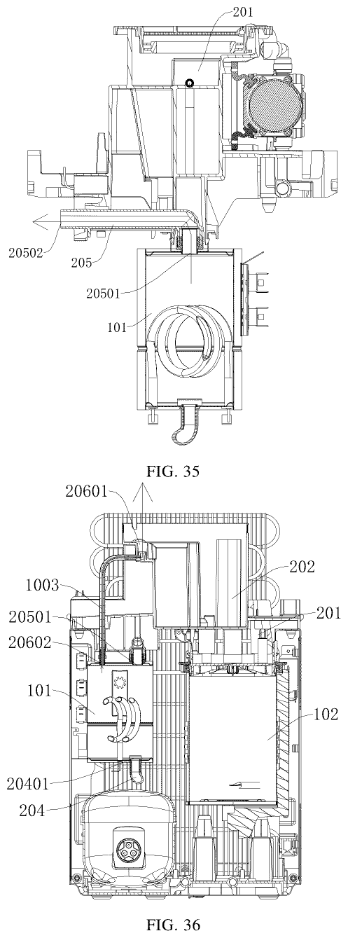

A drinking apparatus 100 according to embodiments of the present disclosure is described in detail below with reference to FIG. 1 to FIG. 36. The drinking apparatus 100 includes a water treatment device 1, a water inlet device 2, and a water outlet device 3.

In an exemplary embodiment of the present disclosure, the water inlet device 2 has a port of a water source 1001 (herein referred to as a water source 1000 port), a water treatment port, a water outlet port, and a first flow passageway assembly. The water source 1001 port is configured to be connected to the water source 1001. The water treatment port is configured to be connected to the water treatment device 1. The water outlet port is configured to be connected to the water outlet device 3. The water source 1001 port, the water treatment port, and the water outlet port are connected by the first flow passageway assembly. Therefore, the water inlet device 2 can integrate flow channels of the drinking apparatus 100, improving reliability and production efficiency.

When the drinking apparatus 100 is in operation, water flow can flow into the water inlet device 2 from the water source 1001 port and flow along the first flow passageway assembly in the water inlet device 2. By being guided by the first flow passageway assembly, the water flow can flow to the water treatment device 1 through the water treatment port to facilitate treatment of the water flow. By being guided by the first flow passageway assembly, the water flow can further flow to the water outlet device 3 through the water outlet port, and flow out of the drinking apparatus 100 by means of the water outlet device 3. It can be understood that the first flow passageway assembly may include a plurality of flow passageways, and the plurality of flow passageways can guide the water flow to flow to the water treatment device 1 and the water outlet device 3 respectively. A water outlet component 8 may include a room temperature water outlet member 804, a hot water outlet member 805, and a cold water outlet member 806. The water treatment device 1 may include a heating tank component 101, a cooling tank component 102, and a filtering component, to meet a daily drinking demand of a user.

In addition, the first flow passageway assembly is integrated at the water inlet device 2, which can improve assembly efficiency of the drinking apparatus 100, thereby improving the production efficiency. During assembling, the water outlet device 3 and the water treatment device 1 can be mounted at the water inlet device 2. In this way, the first flow passageway assembly in the water inlet device 2 can be in communication with the water outlet device 3 and the water treatment device 1 respectively, which is convenient for dispensing the water flow to the water outlet device 3 and the water treatment device 1. As a result, it is convenient to realize water outlet function and water treatment function of the drinking apparatus 100. Compared with the related art in which the water source 1001, the water outlet device 3, and the water treatment device 1 are connected by a silicone tube, the water inlet device 2 according to the embodiments of the present disclosure is more reliable.

The water outlet device 3 has a second flow passageway assembly, a first port 3011, and a second port 3012. One of the first port 3011 and the second port 3012 is configured to be connected to the water inlet device 2, and another one of the first port 3011 and the second port 3012 is configured to be connected to the water outlet component 8. The first port 3011 and the second port 3012 are in communication with each other via the second flow passageway assembly. In an exemplary embodiment of the present disclosure, the water inlet device 2 can be connected to the water outlet component 8 by the second flow passageway assembly. An extending length of the second flow passageway assembly may be designed based on a distance between the water inlet device 2 and the water outlet component 8. In addition, there is a port that can directly communicate the water inlet device 2 with the water outlet component 8. Water treated by the water inlet device 2 can flow out from the water outlet component 8 after flowing into the second flow passageway assembly, allowing the water to be delivered between the water inlet device 2 and the water outlet component 8. In an exemplary embodiment of the present disclosure, the water outlet device 3 has the second flow passageway assembly capable of delivering water. Since the first port 3011 and the second port 3012 are in communication with each other via the second flow passageway assembly, during the assembling, the first port 3011 can be directly connected to the water inlet device 2, and the water outlet component 8 can be connected to the second port 3012 of the water outlet device 3. By arranging the water outlet device 3 between the water inlet device 2 and the water outlet component 8, the water can be delivered from the water inlet device 2 to the water outlet component 8. Therefore, a structure is simple and easy to be constructed.

According to the drinking apparatus 100 of the embodiments of the present disclosure, an internal structure of the drinking apparatus 100 is simplified by arranging the water inlet device 2 and the water outlet device 3 with a high integration degree, and the stability and reliability of the system are improved. Various water treatment functions (such as heating, refrigerating, and filtering) can be realized without increasing too much cost, to meet demands of different users. A modularized assembly mode can greatly reduce the complexity of a production line, reduce the production cost, and improve production efficiency.

In some embodiments of the present disclosure, as shown in FIG. 1 to FIG. 4, the water inlet device 2 includes an inlet water manifold 201 and a room temperature water dispensing basin 202. The inlet water manifold 201 and the room temperature water dispensing basin 202 are connected to each other. The water source 1001 port, the water treatment port, the water outlet port, and the first flow passageway assembly are all formed at the inlet water manifold 201. The water source port 1001 is in communication with the room temperature water dispensing basin 202. That is, the room temperature water dispensing basin 202 can be connected to the water source 1001. Water can be stored in the room temperature water dispensing basin 202, and the water stored in the room temperature water dispensing basin 202 can flow out from the first flow passageway assembly.

In some embodiments, by integrally forming the inlet water manifold 201 and the room temperature water dispensing basin 202, connections between the inlet water manifold 201 and the room temperature water dispensing basin 202 can be reduced, and a mounting process of the water inlet device 2 can be simplified. Therefore, assembly steps and time can be reduced, and maintenance and overhaul can be made more convenient and faster. In addition, an integrated design can reduce potential leakage sites, allowing sealing performance between the inlet water manifold 201 and the room temperature water dispensing basin 202 to be improved. The integrated design further enables the water inlet device 2 to have better structural stability and pressure resistance, which can reduce failures caused by loose joints or member wear, thereby effectively prolonging a service life of the water inlet device 2. In addition, the integrated design contributes to a compact layout that saves mounting space better.

In an exemplary embodiment of the present disclosure, an integrated member may adopt manufacturing technologies such as injection molding, casting, or 3D printing, which can realize a highly accurate size control and a complex internal structure design, which is beneficial to improving the service performance of the integrated member.

In some embodiments of the present disclosure, referring to FIG. 1 to FIG. 4, the first flow passageway assembly includes a first flow passageway 203 and a second flow passageway 204. The first flow passageway 203 has a first inlet 20301 and a first outlet 20302. The second flow passageway 204 has a second inlet and a second outlet 20401. The first inlet 20301 and the second inlet 20302 are configured as the water source 1001 port. The second outlet 20401 is configured as the water treatment port and to supply water to a first water treatment component. The first outlet 20302 is configured as the water outlet port and to discharge the water from the water source 1001 out of the drinking apparatus 100.

Thus, the first flow passageway 203 and the second flow passageway 204 are integrated at the water inlet device 2, which can improve the integration degree and reliability of the drinking apparatus 100.

The first inlet 20301 of the first flow passageway 203 may be connected to the water source 1001, and the first outlet 20302 of the first flow passageway 203 may be connected to the water outlet device 3. That is, the water flow from the water source 1001 may sequentially flow through the first inlet 20301, the first flow passageway 203, and the first outlet 20302, and then flow to the water outlet device 3. Finally, the water flow is discharged out of the drinking apparatus 100 by the water outlet device 3 to realize water outflowing of the drinking apparatus 100. The second inlet of the second flow passageway 204 may be connected to the water source 1001, and the second outlet 20401 of the second flow passageway 204 may be connected to the first water treatment component. That is, the water flow from the water source 1001 may sequentially flow through the second inlet, the second flow passageway 204, and the second outlet 20401, and then flow to the first water treatment component. Finally, the water flow may be treated by the first water treatment component. In addition, the first water treatment component may be the heating tank component 101 to heat the water flow flowing through the heating tank, and the first water treatment component may also be the cooling tank component 102 to refrigerate the water flow flowing through the cooling tank.

Referring to FIG. 1 to FIG. 4, in some embodiments of the present disclosure, the second inlet is in communication with the first flow passageway 203, which can further improve the integration degree of the drinking apparatus 100. It can be understood that when the water flow flows through the first flow passageway 203, a part of the water flow may continue to flow along the first flow passageway 203 and then flow to the water outlet device 3, and another part of the water flow may flow to the second flow passageway 204 and then flow to the water treatment device 1. That is, since the second flow passageway 204 is integrated at the first flow passageway 203, the integration degree of the drinking apparatus 100 can be improved.

According to practical situations, the first flow passageway 203 and the second flow passageway 204 may further be two mutually independent flow passageways.

In some embodiments of the present disclosure, the first flow passageway assembly further includes a third flow passageway 205 having a third inlet 20501 and a third outlet 20502. The third inlet 20501 is configured as the water treatment port and to receive water treated by the first water treatment component. The third outlet 20502 is configured as the water outlet port and to discharge the water treated by the first water treatment component out of the drinking apparatus 100. Thus, by integrating the third flow passageway 205 at the water inlet device 2, the integration degree and reliability of the drinking apparatus 100 can be further improved.

In an exemplary embodiment of the present disclosure, in combination with the above embodiments, the first water treatment component may be the hot water tank component 101. That is, the water flow in the hot water tank component 101 may sequentially flow through the third inlet 20501, the third flow passageway 205, and the third outlet 20502, and then flow to the water outlet device 3. Hot water is discharged out of the drinking apparatus 100 by the water outlet device 3 to meet a hot water demand of the user.

In some embodiments of the present disclosure, as shown in FIG. 1 to FIG. 4, the water inlet device 2 further has a first exhaust passage 1003 formed at the inlet water manifold 201. The first exhaust passage 1003 has a first air inlet 20602 and a first exhaust vent 20601. The first air inlet 20602 is configured to be connected to the first water treatment component. The first exhaust vent 20601 is configured to be in communication with an atmosphere to balance an air pressure within the first water treatment component. In an exemplary embodiment of the present disclosure, the first exhaust passage 1003 may be integrated at the inlet water manifold 201. When the first water treatment component is mounted at the water inlet device 2, the first water treatment component may be connected to the first air inlet 20602 of the first exhaust passage 1003. When the water flow flows into the first water treatment component, air in the first water treatment component may be exhausted through the first exhaust passage 1003. In combination with the above embodiments, the first water treatment component may be the heat tank component 101 to heat the water flow flowing through the heat tank. During heating, an internal pressure of the heat tank component 101 increases. The first exhaust passage 1003 can release the pressure of the heating tank component 101, thereby improving operation stability of the drinking apparatus 100.

In some embodiments of the present disclosure, the water inlet device 2 further incudes a first exhaust tube 206 extending through the inlet water manifold 201. The first exhaust passage 1003 is formed in the first exhaust tube 206, or the first exhaust passage 1003 is integrated at the inlet water manifold 201.

It can be understood that the inlet water manifold 201 has an avoidance hole 207. The avoidance hole 207 extends through opposite sides of the inlet water manifold 201. An end of the first exhaust tube 206 may be connected to the first water treatment component, and another end of the first exhaust tube 206 may be in communication with the atmosphere. The first exhaust tube 206 may pass through the avoidance hole 207, allowing an arrangement of the water inlet device 2 to be more compact, and a space utilization rate of the drinking apparatus 100 to be improved.

In other embodiments of the present disclosure, the first exhaust passage 1003 is integrated at the inlet water manifold 201. That is, the inlet water manifold 201 has the first exhaust passage 1003. When the first water treatment component is mounted at the water inlet device 2, the first water treatment component may be in communication with the first air inlet 20602 of the first exhaust passage 1003 to balance the air pressure within the first water treatment component.

In some embodiments of the present disclosure, the first exhaust vent 20601 of the first exhaust passage 1003 is in communication with an internal space of the room temperature water dispensing basin 202. In this way, the air pressure within the first water treatment component can be balanced, and an external environment can be prevented from polluting an interior of the drinking apparatus 100. When water is supplied to the water treatment device 1 from the room temperature water dispensing basin, the water treatment device 1 can exhaust air in the water treatment device 1 to the room temperature water basin via the first exhaust passage 1003, to maintain the balance of the air pressure within the water treatment device 1. Compared with a case where the air in the water treatment device 1 is exhausted to the outside, in the embodiments of the present disclosure, the external environment can be prevented from polluting the interior of the water treatment device 1.

In some embodiments of the present disclosure, the water inlet device 2 further has a second exhaust passage 1004 formed at the inlet water manifold 201. The second exhaust passage 1004 has a second air inlet 20801 and a second exhaust vent 20802. The second air inlet 20801 is configured to be connected to a second water treatment component. The second exhaust vent 20802 is configured to be in communication with an atmosphere to balance an air pressure within the second water treatment component. In an exemplary embodiment of the present disclosure, the second exhaust passage 1004 may be integrated at the inlet water manifold 201. When the second water treatment component is mounted at the water inlet device 2, the second water treatment component may be connected to the second air inlet 20801 of the second exhaust passage 1004. When the water flow flows into the second water treatment component, air in the second water treatment component can be exhausted via the second exhaust passage 1004. In combination with the above embodiments, the second water treatment component may be the cooling tank component 102 to heat the water flow flowing through the heating tank. During heating, an internal pressure of the cooling tank component 102 increases. The pressure of the cooling tank component 102 can be released through the second exhaust passage 1004, thereby improving the operation stability of the drinking apparatus 100.

Further, as shown in FIG. 1 to FIG. 9, the water inlet device 2 further includes a second exhaust tube 208 extending through the inlet water manifold 201. The second exhaust passage 1004 is formed in the second exhaust tube 208, or the second exhaust passage 1004 is integrated at the inlet water manifold 201. It can be understood that the inlet water manifold 201 has the avoidance hole 207 extending through opposite sides of the inlet water manifold 201. An end of the second exhaust tube 208 may be connected to the second water treatment component, and another end of the second exhaust tube 208 may be in communication with the atmosphere. The second exhaust tube 208 may pass through the avoidance hole 207, allowing the arrangement of the water inlet device 2 to be more compact, and the space utilization rate of the drinking apparatus 100 to be improved.

In other embodiments of the present disclosure, the second exhaust passage 1004 is integrated at the inlet water manifold 201. That is, the inlet water manifold 201 has the second exhaust passage 1004. When the second water treatment component is mounted at the water inlet device 2, the second water treatment component can be in communication with the second air inlet 20801 of the second exhaust passage 1004 to balance the air pressure within the second water treatment component.

In some embodiments, the second exhaust vent 20802 of the second exhaust passage 1004 is in communication with an internal space of the room temperature water dispensing basin 202. In this way, the air pressure within the second water treatment component can be balanced, and the external environment can be prevented from polluting the interior of the drinking apparatus 100. When the water is supplied to the water treatment device 1 from the room temperature water dispensing basin 202, the water treatment device 1 can exhaust the air in the water treatment device 1 to the room temperature water dispensing basin 202 through the second exhaust passage 1004, to maintain the balance of the air pressure within the water treatment device 1. Compared with the case where the air in the water treatment device 1 is exhausted to the outside, in the embodiments of the present disclosure, the external environment can be prevented from polluting the interior of the water treatment device 1.

In some embodiments of the present disclosure, as shown in FIG. 1 to FIG. 9, the first flow passageway assembly further includes a fourth flow passageway 209. The fourth flow passageway 209 has a fourth inlet 20901 and a fourth outlet 20902. The fourth inlet 20901 is configured as the water source 1001 port. The fourth outlet 20902 is configured as the water treatment port and to supply water to a second water treatment component. Thus, by integrating the fourth flow passageway 209 at the water inlet device 2, the integration degree and reliability of the drinking apparatus 100 are improved.

The fourth inlet 20901 of the fourth flow passageway 209 may be connected to the water source 1001, and the fourth outlet 20902 of the fourth flow passageway 209 may be connected to the second water treatment component. That is, the water flow from the water source 1001 may sequentially flow through the fourth inlet 20901, the fourth flow passageway 209, and the fourth outlet 20902, and then flow to the second water treatment component. Finally, the water flow is treated by the second water treatment component. In addition, the second water treatment component may be the cooling tank component 102 to refrigerate the water flow flowing through the cooling tank, and the second water treatment component may also be the heating tank component 101.

In some embodiments of the present disclosure, as shown in FIG. 1 to FIG. 9, the first flow passageway assembly further includes a fifth flow passageway 2010. The fifth flow passageway 2010 has a fifth inlet 201001 and a fifth outlet 201002. The fifth inlet 201001 is configured as the water treatment port and to receive water treated by a second water treatment component. The fifth outlet 201002 is configured as the water outlet port and to discharge the water treated by the second water treatment component out of the drinking apparatus 100. Thus, by integrating the fifth flow passageway 2010 at the water inlet device 2, the integration degree and reliability of the drinking apparatus 100 can be further improved.

In an exemplary embodiment of the present disclosure, in combination with the above embodiments, the second water treatment component may be the cooling tank component 102. That is, the water flow in the cooling tank component 102 may sequentially flow through the fifth inlet 201001, the fifth flow passageway 2010, and the fifth outlet 201002, and then flow to the water outlet device 3. Cold water is discharged out of the drinking apparatus 100 by the water outlet device 3 to meet a cold water demand of the user.

In some embodiments of the present disclosure, the first flow passageway assembly further includes a sixth flow passageway 2011. The sixth flow passageway 2011 has a sixth inlet 201101 configured to be connected to the water source 1001 and a sixth outlet 201102 configured to supply water to a water pump 14. That is, the sixth flow passageway 2011 is integrated at the water inlet device 2, which can further improve the integration degree and reliability of the drinking apparatus 100.

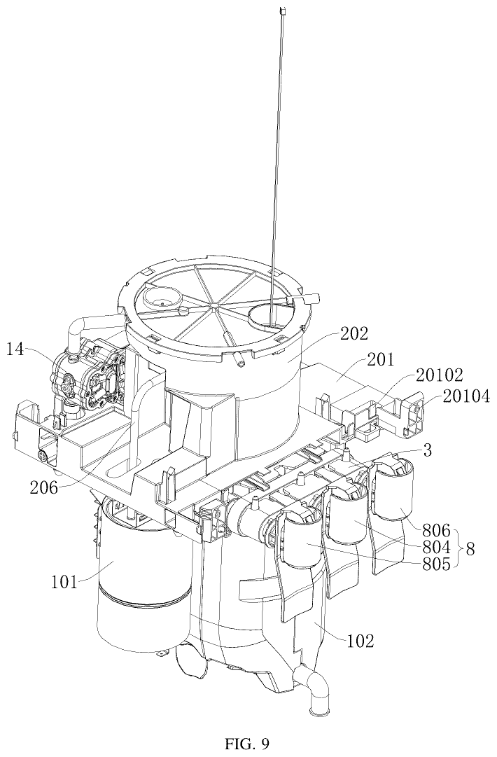

In detail, as shown in FIG. 9, a water pump 14 is disposed in the drinking apparatus 100. The water pump 14 may be connected to the water source 1001 and the room temperature water dispensing basin 202 respectively to drive the water flow in the water source 1001 to flow to the room temperature water dispensing basin 202. The water pump 14 and the water source 1001 are required to be connected to each other by the sixth flow passageway 2011. Therefore, the sixth flow passageway 2011 may be integrated at the inlet water manifold 201, the sixth inlet 201101 of the sixth flow passageway 2011 may be connected to the water source 1001, and the sixth outlet 201102 of the sixth flow passageway 2011 may be connected to the water pump 14. In this way, the integration degree and reliability of the drinking apparatus 100 can be further improved, and an arrangement space in the drinking apparatus 100 can be saved.

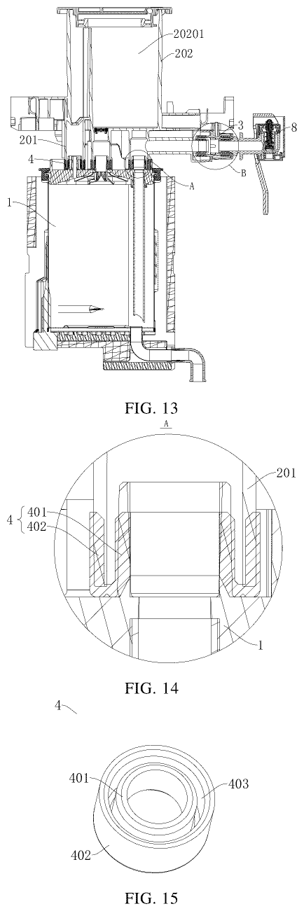

In some embodiments of the present disclosure, as shown in FIG. 13 to FIG. 16, the water inlet device 2 further includes a first seal 4. The water treatment port is engaged with a treatment connection tube of the water treatment device 1 through insertion. At least part of the first seal 4 is disposed between a peripheral wall of the water treatment port and the treatment connection tube of the water treatment device 1. A radial compression amount of the at least part of the first seal 4 is greater than or equal to 15% and smaller than or equal to 20%. In this way, a main body portion and the water treatment device 1 can be conveniently disassembled and assembled.

In another exemplary embodiment of the present disclosure, the water treatment device 1 has a treatment connection tube. A connection tube of the water treatment device 1 may be inserted at an inner side of the peripheral wall of the water treatment port. The at least part of the first seal 4 may be disposed at the inner side of the peripheral wall of the water treatment port. When the connection tube of the water treatment device 1 is engaged with the peripheral wall of the water treatment port through insertion, the least part of the first seal 4 can seal a gap between the connection tube of the water treatment device 1 and the peripheral wall of the water treatment port. The radial compression amount of the at least part of the first seal 4 is greater than or equal to 15% and smaller than or equal to 20%. With such an arrangement, a service life of the first seal 4 can be prolonged while meeting sealing performance requirements. Further, rapid assembly and disassembly is facilitated between the inlet water manifold 201 and the water treatment device 1. In another exemplary embodiment of the present disclosure, the connection tube of the water treatment device 1 may be inserted at an outer side of the peripheral wall of the water treatment port. The at least part of the first seal 4 may be disposed at the outer side of the peripheral wall of the water treatment port to seal a gap between the inlet water manifold 201 and the water treatment device 1 and provide a contact pressure for a connection between the inlet water manifold 201 and the water treatment device 1. Therefore, the inlet water manifold 201 and the water treatment device 1 can be quickly disassembled and reassembled conveniently.

The radial compression of the at least part of the first seal 4 may be 15%, 16%, 17%, 18%, 19%, 20%, etc.

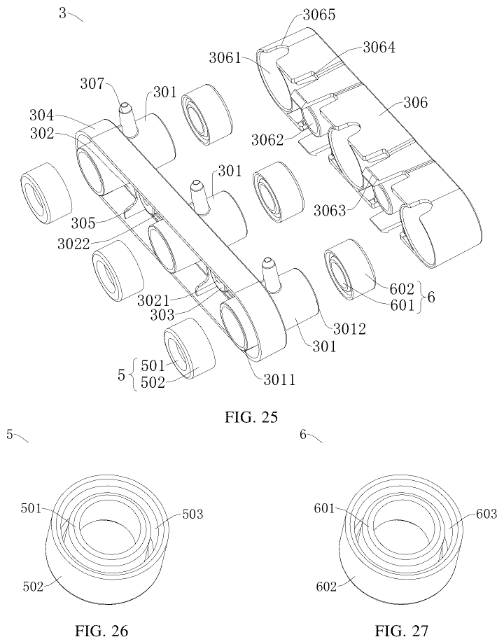

In some embodiments of the present disclosure, as shown in FIG. 13 to FIG. 16, FIG. 25, and FIG. 26, the water inlet device 2 further includes a second seal 5. The water outlet port is engaged with a water outlet connection tube 301 of the water outlet device 3 through insertion. At least part of the second seal 5 is disposed between a peripheral wall of the water outlet port and the water outlet connection tube 301 of the water outlet device 3. A radial compression amount of the at least part of the second seal 5 is greater than or equal to 15% and smaller than or equal to 20%. In this way, the main body portion and the water outlet device 3 can be conveniently disassembled and assembled.

In another exemplary embodiment of the present disclosure, the water outlet device 3 has a connection tube. The connection tube of the water outlet device 3 may be inserted at an inner side of the peripheral wall of the water outlet port. The at least part of the second seal 5 may be disposed at the inner side of the peripheral wall of the water outlet port. When the connection tube of the water outlet device 3 is engaged with the peripheral wall of the water outlet port through insertion, the at least part of the second seal 5 can seal a gap between the connection tube of the water outlet device 3 and the peripheral wall of the water outlet port. The radial compression amount of the at least part of the second seal 5 is greater than or equal to 15% and smaller than or equal to 20%. In this way, the service life of the second seal 5 is prolonged while meeting the sealing performance requirements. Therefore, rapid disassembly and assembly is facilitated between the inlet water manifold 201 and the water outlet device 3. In another exemplary embodiment of the present disclosure, the connection tube of the water outlet device 3 may be inserted at an outer side of the peripheral wall of the water outlet port. The at least part of the second seal 5 may be disposed at the outer side of the peripheral wall of the water outlet port, to seal a gap between the inlet water manifold 201 and the water outlet device 3 and provide a contact pressure for a connection part between the inlet water manifold 201 and the water outlet device 3. Therefore, the inlet water manifold 201 and the water outlet device 3 can be quickly disassembled and reassembled conveniently.

The radial compression of at least part of the second seal 5 may be 15%, 17%, 18%, 20%, etc.

In some embodiments of the present disclosure, the inlet water manifold 201 has a first surface and a second surface opposite to each other in a thickness direction the inlet water manifold 201. The water source 1001 port is formed at the first surface. The room temperature water dispensing basin 202 is connected to the inlet water manifold 201, and a water storage chamber 20201 is enclosed and defined by the room temperature water dispensing basin 202. The water source 1001 port is formed in the room temperature water dispensing basin 202. Therefore, the first flow passageway assembly of the drinking apparatus 100 can be integrated at the water inlet device 2, thereby improving the reliability and production efficiency.

In an exemplary embodiment of the present disclosure, when the drinking apparatus 100 is in operation, water flow may flow into the water inlet device 2 from the water source 1001 port and flow along the first flow passageway assembly in the water inlet device 2. By being guided by the first flow passageway assembly, the water flow may flow to the water treatment device 1 through the water treatment port, to facilitate treatment of the water flow. By being guided by the first flow passageway assembly, the water flow may further flow to the water outlet device 3 through the water outlet port, and flow out of the drinking apparatus 100 through the water outlet component 8. It can be understood that the first flow passageway assembly may include the plurality of flow passageways, and the plurality of flow passageways may guide the water flow to flow to the water treatment device 1 and the water outlet device 3 or the water outlet component 8, respectively. The water outlet component 8 may include the room temperature water outlet member 804, the hot water outlet member 805, and the cold water outlet member 806. The water treatment device 1 may include the heating tank component 101, the heating tank component 102, and the filtering component, to meet the daily drinking demand of the user.

In addition, the first flow passageway assembly is integrated at the water inlet device 2, which can improve the assembly efficiency of the drinking apparatus 100, thereby improving production efficiency. During the assembling, the water outlet device 3 and the water treatment device 1 may be mounted at the water inlet device 2. In this way, the first flow passageway assembly in the water inlet device 2 is in communication with the water outlet device 3 and the water treatment device 1, which is convenient for dispensing the water flow to the water outlet device 3 and the water treatment device 1. Therefore, it is convenient to realize the water outlet function and the water treatment function of the drinking apparatus 100. Compared with the related art in which the water source 1001, the water outlet device 3, and the water treatment device 1 are connected by a silicone tube, the water inlet device 2 according to the embodiments of the present disclosure is more reliable.

In addition, in practice, the first surface of the inlet water manifold 201 may face upwards, and the second surface of the inlet water manifold 201 may face downwards. The room temperature water dispensing basin 202 is connected to the first surface of the inlet water manifold 201. The room temperature water dispensing basin 202 extends along the thickness direction, and the water storage chamber 20201 is enclosed and defined by room temperature water dispensing basin 202. In combination with the above embodiments, the water source 1001 port is formed at the first surface and located in the room temperature water dispensing basin 202. The water treatment port is provided at the second surface. The water outlet port is formed at the third surface. That is, the water source 1001 port is located above the water treatment port and the water outlet port in an up-down direction. When the drinking apparatus 100 is in operation, since the room temperature water dispensing basin 202 is located at an upper side of the inlet water manifold 201, a liquid level of the room temperature water dispensing basin 202 is located higher than a liquid level of the water treatment device 1. Under an atmospheric pressure, the water flow in the room temperature water dispensing basin 202 can be driven to flow to the water outlet port through the first flow passageway assembly, and the water flow in the water treatment device 1 can further be driven to flow to the water outlet port through the first flow passageway assembly, to realize water outflowing from the drinking apparatus 100.

In some embodiments of the present disclosure, the inlet water manifold 201 has a first positioning component configured for mounting of a first water treatment component; and/or the inlet water manifold 201 has a second positioning component configured for mounting of a second water treatment component; and/or the inlet water manifold 201 has a third positioning component configured to connect the water inlet device 2 with a housing 13 of the drinking apparatus 100.

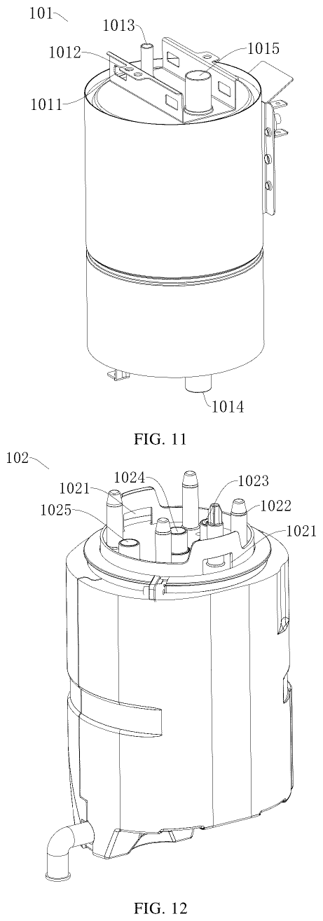

In some embodiments, the water treatment device 1 includes the first water treatment component. The inlet water manifold 201 has a first positioning component configured for mounting of the first water treatment component. As shown in FIG. 11, the first water treatment device may be the heating tank component 101, and the heating tank component 101 has a first extension portion extending towards the inlet water manifold 201. The first extension portion has a plurality of first engagement slots 1011. The first positioning component of the inlet water manifold 201 includes a plurality of first engagement protrusions. The plurality of first engagement protrusions are correspondingly engaged into the plurality of first engagement slots 1011 to realize a connection between the heating tank component 101 and the water inlet device 2. In addition, the heating tank component 101 further has a flange connected to an end of the first extension portion adjacent to the inlet water manifold 201. The flange extends from the second surface and has a plurality of first positioning holes 1012, and the first positioning component of the inlet water manifold 201 includes a plurality of second positioning holes. The plurality of first positioning holes 1012 and the plurality of second positioning holes are in one-to-one correspondence and are connected to each other by fasteners to realize the connection between the heating tank component 101 and the water inlet device 2. After the connection is completed, the water treatment port of the inlet water manifold 201 can be in communication with an interior of the heating tank component 101 to realize water inflowing and outflowing of the heating tank component 101.

In addition, the water treatment device 1 further includes the second water treatment component. The inlet water manifold 201 further includes the second positioning component configured for mounting of the second water treatment component. As shown in FIG. 12, the second water treatment component may be the cooling tank component 102, and the cooling tank component 102 has a second extension portion extending towards the inlet water manifold 201. The second extension portion has a plurality of second engagement slots 1021. The second positioning component of the inlet water manifold 201 includes a plurality of second engagement protrusions. The plurality of second engagement protrusions are correspondingly engaged into the plurality of second engagement slots 1021 to realize a connection between the cooling tank component 102 and the water inlet device 2. In addition, the cooling tank component 102 further has a plurality of first positioning posts 1022 extending towards the inlet water manifold 201. The second positioning component of the inlet water manifold 201 includes a plurality of first positioning grooves. The plurality of first positioning posts 1022 are correspondingly inserted into the plurality of first positioning grooves to realize the connection between the cooling tank component 102 and the water inlet device 2. After the connection is completed, the water treatment port of the inlet water manifold 201 can be in communication with an interior of the cooling tank component 102 to realize water inflowing and outflowing of the cooling tank component 102.

In addition, referring to FIG. 1 to FIG. 9, the inlet water manifold 201 further has the third positioning component configured to connect the water inlet device 2 with the housing 13 of the drinking apparatus 100. The third positioning component includes a plurality of second positioning posts 20101. The housing 13 of the drinking apparatus 100 has a plurality of second positioning grooves. The plurality of second positioning posts 20101 are correspondingly inserted into the plurality of second positioning grooves. In addition, the third positioning component further includes a plurality of third positioning holes 20104, and the housing 13 of the drinking apparatus 100 has a plurality of fourth positioning holes. The plurality of third positioning holes 20104 and the plurality of fourth positioning holes are in one-to-one correspondence and are connected to each other through fasteners, thereby realizing a connection between the water inlet device 2 and the housing 13 of the drinking apparatus 100.

Further, the inlet water manifold 201 has a fourth positioning component configured to be snapped to an electric control box component; and/or the inlet water manifold 201 has a first connection portion connected to the water pump 14 by a fastener; and/or the inlet water manifold 201 further has a plurality of positioning portions 20103 configured to position a wiring harness in the drinking apparatus 100. The fourth positioning component includes a plurality of third engagement protrusions 20102. The electric control box component has a plurality of third engagement slots 3022. The plurality of third engagement protrusions 20102 are correspondingly engaged into the plurality of third engagement slots 3022, to realize assembling of the electric control box component on the water inlet device 2.

In addition, the inlet water manifold 201 has a plurality of first connection portions. The water pump 14 has a plurality of second connection portions. The plurality of first connection portions and the plurality of second connection portions are in one-to-one correspondence and are connected to each other by fasteners, allowing the water pump 14 to be mounted at the inlet water manifold 201.

In addition, at least one of the first surface, the second surface, and the third surface of the inlet water manifold 201 is provided with a positioning portion 20103 configured to position at least part of the wiring harness in the drinking apparatus 100. In this way, the cleanliness of the interior of the drinking apparatus 100 is improved, and the wiring harness is prevented from interfering with structural members in the interior of the drinking apparatus 100.

In detail, the drinking apparatus 100 is provided with the water pump 14. The water pump 14 may be connected to the water source 1001 and the room temperature water dispensing basin 202, and is configured to drive the water flow in the water source 1001 to flow to the room temperature water dispensing basin 202. The water pump 14 needs to be connected to the water source 1001 via the sixth flow passageway 2011. Therefore, the sixth flow passageway 2011 can be integrated at the inlet water manifold 201, the sixth inlet 201101 of the sixth flow passageway 2011 can be connected to the water source 1001, and the sixth outlet 201102 of the sixth flow passageway 2011 can be connected to the water pump 14. In this way, the integration degree and reliability of the drinking apparatus 100 can be further improved, and the arrangement space in the drinking apparatus 100 can be saved.

In some embodiments of the present disclosure, the water treatment port is provided at the second surface; or the inlet water manifold 201 further has a third surface extending parallel to the thickness direction, and the water outlet port is formed at the third surface. In an exemplary embodiment of the present disclosure, in combination with the above embodiments, the water source 1001 port is formed at the first surface. The water treatment port is provided at the second surface. The water outlet port is formed at the third surface. In this way, during the assembling, the water source 1001 can be disposed at the first surface, the water treatment device 1 can be disposed at the second surface, and the water outlet device 3 can be disposed at the third surface. Therefore, mutual interference among the water source 1001, the water treatment device 1, and the water outlet device 3 can be avoided.

Further, a plurality of water outlet ports are provided and arranged side by side at the inlet water manifold 201; and/or the water treatment port is constructed into a tubular shape extending in the thickness direction; and/or the water outlet port is constructed into a tubular shape extending in a direction perpendicular to the thickness direction.

Referring to FIG. 4, in some embodiments of the present disclosure, the plurality of water outlet ports is provided. In combination with the above embodiments, the water outlet component 8 may include the room temperature water outlet member 804, the hot water outlet member 805, and the cold water outlet member 806. The water outlet port may be connected to the water outlet device 3. Thus, the plurality of water outlet ports can be arranged side by side at the inlet water manifold 201, and the plurality of water outlet ports can be connected to the room temperature water outlet member 804, the hot water outlet member 805, and the cold water outlet member 806. Therefore, the room temperature water outlet function, the hot water outlet function, and cold water outlet function of the drinking apparatus 100 can be realized.

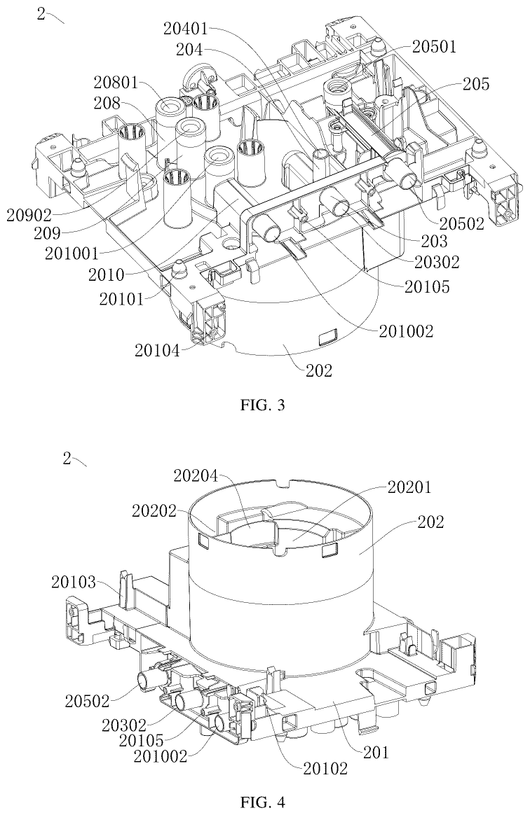

Referring to FIG. 3, in some embodiments of the present disclosure, the water treatment port is constructed into a tubular shape extending in the thickness direction; and/or the water outlet port is constructed into a tubular shape extending in the direction perpendicular to the thickness direction. Such an arrangement can facilitate a connection of the inlet water manifold 201 to the water treatment device 1 and the water outlet device 3.

In combination with the above embodiments, the inlet water manifold 201 may be engaged with the connection tube of the water treatment device 1 by the water treatment port through insertion. Therefore, the water treatment port can be constructed into a tubular shape extending in the thickness direction of the inlet water manifold 201. In this way, a connection area between the water treatment port and the connection tube of the water treatment device 1 can be increased, thereby improving the connection stability between the inlet water manifold 201 and the water treatment device 1. Similarly, the inlet water manifold 201 may be engaged with the connection tube of the water outlet device 3 by the water outlet port through insertion. Therefore, the water outlet port can be constructed into a tubular shape extending in the thickness direction of the inlet water manifold 201. In this way, a connection area between the water outlet port and the connection tube of the water outlet device 3 can be increased, thereby improving the connection stability between the inlet water manifold 201 and the water outlet device 3.

In some embodiments of the present disclosure, as shown in FIG. 1 and FIG. 2, the room temperature water dispensing basin 202 has a first buffer chamber 20202. The first water treatment component has a first water port 1014, a second water port 1015, and a first ventilation port 1013. The first water port 1014 is connected to the second outlet 20401 and is in communication with the water storage chamber 20201 via the second flow passageway 204 to supply water to the first water treatment component. The second water port 1015 is connected to the third inlet 20501 and is in communication with the third outlet 20502 via the third flow passageway 205 to discharge the water treated by the first water treatment component out of the drinking apparatus 100. The first ventilation port 1013 is connected to the first air inlet 20602 and is in communication with the first buffer chamber 20202 via the first exhaust passage 1003 to balance the air pressure within the first water treatment component.

The room temperature water dispensing basin 202 has the water storage chamber 20201 and the first buffer chamber 20202. The water storage chamber 20201 is configured to store room temperature water, and the first buffer chamber 20202 is configured to buffer fluid discharged from the first water treatment component. The first water treatment component has the first water port 1014 and the first ventilation port 1013. The first water port 1014 is in communication with the water storage chamber 20201, and the first ventilation port 1013 is in communication with the first buffer chamber 20202. Therefore, according to the drinking apparatus 100 in the embodiments of the present disclosure, temperature cross-contamination between the room temperature water and exhaust air of the water treatment device 1 can be avoided, allowing a temperature of the room temperature water to be stable and the user experience to be improved.

In an exemplary embodiment of the present disclosure, to balance the air pressure within the first water treatment component and prevent the external environment from polluting the interior of the drinking apparatus 100, air in the first water treatment component may be discharged into the room temperature water dispensing basin 202. It can be understood that when the first water treatment component is fed with water for the first time, the water flow in the room temperature water dispensing basin 202 may supply water to the first water treatment component from the first water port 1014. During this process, the air in the first water treatment component can be exhausted to the room temperature water dispensing basin 202 to facilitate water flowing into the first water treatment component.

Further, the first water treatment component may be the heating tank component 101, and high-temperature air generated in the heating tank component 101 may be discharged to the first buffer chamber 20202 of the room temperature water dispensing basin 202, to avoid directly discharging the high-temperature air into the water storage chamber 20201 and affecting the temperature stability of the room temperature water. The first water treatment component may also be the cooling tank component 102, and low-temperature air generated in the cooling tank component 102 may be discharged to the first buffer chamber 20202 of the room temperature water dispensing basin 202, to avoid directly discharging the low-temperature air into the water storage chamber 20201 and affecting the temperature stability of the room temperature water.

In addition, the first buffer chamber 20202 may be in communication with the water storage chamber 20201. The high-temperature air generated by the heating tank component 101 may be discharged to the water storage chamber 20201 after being refrigerated in the first buffer chamber 20202, or the high-temperature air may be condensed into liquid in the first buffer chamber 20202 and then discharged to the water storage chamber 20201. In this way, the fluid can be prevented from being directly discharged into the water storage chamber 20201 to cause a drastic temperature change of the room temperature water in the water storage chamber 20201. The first buffer chamber 20202 may further be in communication with outside to allow the high-temperature air generated by the heating tank component 101 to be discharged to outside via the first buffer chamber 20202, thereby avoiding burning the user and reducing external pollutants directly entering the heating tank component 101. Similarly, the low-temperature air generated by the cooling tank component 102 may be discharged to the water storage chamber 20201 via the first buffer chamber 20202, and may further be discharged to the outside via the first buffer chamber 20202 to avoid the drastic temperature change of the room temperature water.

For convenience of understanding, unless otherwise specified, the heating tank component 101 will be described below as the first water treatment component.

Further, as shown in FIG. 1 and FIG. 2, the room temperature water dispensing basin 202 includes a basin body 20206 and a first partition 20204. The first partition 20204 is disposed in the basin body 20206, and the basin body 20206 is divided into the water storage chamber 20201 and the first buffer chamber 20202 by the first partition 20204. In an exemplary embodiment of the present disclosure, the first buffer chamber 20202 is enclosed by a side of the first partition 20204 and an inner circumferential surface of the basin body 20206. The water storage chamber 20201 is enclosed another side of the first partition 20204 and the inner circumferential surface of the basin body 20206. That is, the basin body 20206 is divided into the first buffer chamber 20202 and the water storage chamber 20201 by the first partition 20204. In this way, the integration degree of the room temperature water dispensing basin 202 can be improved, and water storage and buffering functions of the room temperature water dispensing basin 202 can be realized.

In an exemplary embodiment of the present disclosure, the first partition 20204 extends in an up-down direction. A lower end of the first partition 20204 is connected to a bottom wall of the basin body 20206 to separate a bottom of the water storage chamber 20201 from a bottom of the first buffer chamber 20202. The fluid in the first buffer chamber 20202 may be discharged to the water storage chamber 20201 from a top and/or a side of the first partition 20204, to avoid the fluid from being directly discharged to water storage chamber 20201, which would result in the drastic temperature change of the room temperature water.

Further, a gap is formed between an upper end of the first partition 20204 and a top inner surface of the basin body 20206. That is, the bottom of the first buffer chamber 20202 is separated from the bottom of the water storage chamber 20201, and a top of the first buffer chamber 20202 is in communication with a top of the water storage chamber 20201. Therefore, the fluid in the first buffer chamber 20202 can overflow into the water storage chamber 20201. When there is a high-temperature air is in the first buffer chamber 20202, the high-temperature air can be discharged to the water storage chamber 20201 after being refrigerated in the first buffer chamber 20202, thereby avoiding the drastic temperature change in the warm water in the water storage chamber 20201. When liquid refrigerated by high-temperature air is in the first buffer chamber 20202, the liquid can slowly overflow from the upper end of the first partition 20204 to the water storage chamber 20201, thereby avoiding the drastic temperature change in the warm water in the water storage chamber 20201. In short, the fluid in the first buffer chamber 20202 can be slowly discharged to the water storage chamber 20201, thereby improving the temperature stability of the warm water in the water storage chamber 20201. In another embodiment, the upper end of the first partition 20204 is located lower than an upper edge of the basin body 20206.

In other embodiments, the upper end of the first partition 20204 is located lower than the upper edge of the basin body 20206. Therefore, the top of the first buffer chamber 20202 is in communication with the top of the water storage chamber 20201, allowing the fluid in the first buffer chamber 20202 to slowly overflow into the water storage chamber 20201. As a result, the temperature stability of the warm water in the water storage chamber 20201 can be improved.

According to actual conditions, a unidirectional structure may be disposed at a communication between the first buffer chamber 20202 and the water storage chamber 20201. Therefore, the fluid in the first buffer chamber 20202 is discharged to the water storage chamber 20201 and the room temperature water in the water storage chamber 20201 is prevented from flowing to the first buffer chamber 20202. For example, an air permeable membrane is provided to allow air to discharge from the first buffer chamber 20202 to the water storage chamber 20201 while preventing the water flow from flowing from the water storage chamber 20201 to the first buffer chamber 20202. In another embodiment, the first buffer chamber 20202 may be located higher than the water storage chamber 20201 to avoid temperature cross-contamination caused by the room temperature water flowing to the first buffer chamber 20202.

In some embodiments of the present disclosure, the bottom wall of the basin body 20206 includes a first portion and a second portion. The first portion is located lower than the second portion. A step structure is constructed between the first portion and the second portion. The first partition 20204 is connected to the second portion. It can be understood that a height difference exists between the first buffer chamber 20202 and the water storage chamber 20201, and the first buffer chamber 20202 is located higher than the water storage chamber 20201. Therefore, under the action of gravity, the room temperature water in the water storage chamber 20201 cannot easily flow to the first buffer chamber 20202. The fluid in the first buffer chamber 20202 can flow to the water storage chamber 20201 after being buffered and refrigerated. Therefore, the room temperature water in the water storage chamber 20201 is maintained within a predetermined range, and the influence of temperature cross-contamination on user experience can be avoided.

Further, the first partition 20204 has a flow return opening, and the water storage chamber 20201 and the first buffer chamber 20202 are in communication with each other via the flow return opening. In another embodiment, a gap between the first partition 20204 and a peripheral wall of the basin body 20206 is formed as a flow return opening, and the water storage chamber 20201 and the first buffer chamber 20202 are in communication with each other via the flow return opening. Thus, bacteria generated due to accumulated water in the first buffer chamber 20202 can be avoided, and drinking hygiene of the drinking apparatus 100 can be ensured.

In combination with the foregoing description, when water vapor is discharged from the heat tank component 101 to the first buffer chamber 20202, the water vapor can be partially condensed into liquid, and the liquid in the first buffer chamber 20202 gradually increases and overflows from the upper end of the first partition 20204 to the water storage chamber 20201. However, when the heating tank component 101 is not exhausted, the accumulated water in the first buffer chamber 20202 does not flow, and bacteria may breed in the first buffer chamber 20202 with time, affecting the health of the user. Therefore, the flow return opening for communicating the water storage chamber 20201 with the first buffer chamber 20202 may be formed at the first partition 20204. The accumulated water in the first buffer chamber 20202 can flow slowly to the water storage chamber 20201 to prevent bacteria from breeding in the accumulated water in the first buffer chamber 20202.

In addition, in some other embodiments of the present disclosure, the gap is formed between the first partition 20204 and the peripheral wall of the basin body 20206, to construct the flow return opening for communicating the water storage chamber 20201 with the first buffer chamber 20202. In this way, the accumulated water in the first buffer chamber 20202 can slowly flow to the water storage chamber 20201, and bacteria can be prevented from breeding in the first buffer chamber 20202 due to the accumulated water.

Further, a width dimension D of the flow return opening in a circumference of the basin body 20206 is greater than or equal to 0.5 mm and smaller than or equal to 1.5 mm. In this way, the accumulated water in the first buffer chamber 20202 can slowly flow to the water storage chamber 20201, to avoid bacteria breeding due to the accumulated water in the first buffer chamber 20202 while ensuring a buffering effect of the first buffer chamber 20202. The width dimension D may be 0.5 mm, 0.6 mm, 1.0 mm, 1.3 mm, 1.5 mm, etc.

In some embodiments, as shown in FIG. 1 and FIG. 2, the first exhaust vent 20601 is formed in the first buffer chamber 20202. The first exhaust vent 20601 is located higher than a bottom inner surface of the first buffer chamber 20202. When the heating tank component 101 exhausts, air flow may sequentially pass through the first ventilation port 1013 and the first exhaust vent 20601 from the heating tank component 101 and then flow into the first buffer chamber 20202. Combined with the previous embodiment, the heating tank component 101 exhausts to the first buffer chamber 20202 via the first ventilation port 1013, and high-temperature vapor is partially condensed into liquid in the first buffer chamber 20202. To avoid liquid backflow from blocking the first ventilation port 1013 and affecting the exhaust of the heating tank component 101, the first exhaust vent 20601 may be located higher than the bottom inner surface of the first buffer chamber 20202 to improve exhaust stability of the heating tank component 101.

Further, a top of the first buffer chamber 20202 is located higher than a water level in the water storage chamber 20201, and is at a first distance L1 from the water level in the water storage chamber 20201. The first distance L1 is greater than or equal to 10 mm. In this way, the room temperature water in the water storage chamber 20201 can be prevented from flowing to the first buffer chamber 20202 to cause the drastic temperature change of the room temperature water. Therefore, fluid discharged from the first water treatment component can be prevented from being affected.

In another exemplary embodiment of the present disclosure, a water level gauge, a float switch, or the like may be disposed in the water storage chamber 20201. In response to detecting that the liquid level in the water storage chamber 20201 reaches a predetermined value, the water source 1001 stops supplying water to the water storage chamber 20201. In this way, after the drinking apparatus 100 is stably mounted, a water level of the room temperature water in the water storage chamber 20201 is located lower than the top of the first partition 20204, thereby avoiding temperature cross-contamination caused by the communication between the room temperature water in the water storage chamber 20201 and the first buffer chamber 20202. In addition, the first ventilation port 1013 of the first water treatment component can be prevented from being blocked.

In another exemplary embodiment of the present disclosure, a top of the basin body 20206 is open for mounting of an intelligent seat 15. The intelligent seat 15 has an external water inlet and an external air inlet. A water bucket may be placed on the intelligent seat 15. The external water inlet may allow the water storage chamber 20201 to be in communication with the water bucket, and water flow from the water bucket may supply water to the water storage chamber 20201 from the external water inlet. The external air inlet may allow the water bucket to be in communication with the outside atmosphere to balance an air pressure within the water bucket. After the water level in the water storage chamber 20201 reaches a predetermined water level, the water flow in the water storage chamber 20201 may close the external air inlet to isolate the water bucket from the outside atmosphere and prevent the water tank from continuing to supply water to the water storage chamber 20201. In this way, the water level in the water storage chamber 20201 can be maintained at the predetermined value, and is located lower than the top of the first buffer chamber 20202, thereby avoiding temperature cross-contamination caused by the communication between the water flow in the water storage chamber 20201 and the first buffer chamber 20202. In addition, the first ventilation port 1013 of the first water treatment component can be prevented from being blocked.

The first distance L1 between the top of the first buffer chamber 20202 and the water level in the water storage chamber 20201 may be 10 mm, 12 mm, 15 mm, etc.

In some embodiments of the present disclosure, as shown in FIG. 1 and FIG. 2, the room temperature water dispensing basin 202 has a second buffer chamber 20203, and the second water treatment component has a third water port 1024, a fourth water port 1025, and a second ventilation port 1023. The third water port 1024 is connected to the fourth outlet 20902, and is in communication with the water storage chamber 20201 via a fourth flow passageway 209 to supply water to the second water treatment component. The fourth water port 1025 is connected to the fifth inlet 201001, and is in communication with the fifth outlet 201002 via a fifth flow passageway 2010 to discharge the water treated by the second water treatment component out of the drinking apparatus 100. The second ventilation port 1023 is connected to the second air inlet 20801, and is in communication with the second buffer chamber 20203 via the second exhaust passage 1004 to balance the air pressure within the second water treatment component. In this way, the air pressure within the second water treatment component can be balanced, and the external environment can be prevented from polluting the interior of the drinking apparatus 100.

In an exemplary embodiment of the present disclosure, to balance the air pressure within the second water treatment component and avoid the external environment from polluting the interior of the drinking apparatus 100, the air in the second water treatment component can be discharged into the room temperature water dispensing basin 202. It can be understood that when the second water treatment component receives water for the first time, the water flow in the room temperature water dispensing basin 202 may supply water to the second water treatment component from the third water port 1024. During this process, air flow in the second water treatment component may be discharged to the room temperature water dispensing basin 202, to facilitate flowing of water into the second water treatment component.

Further, the second water treatment component can be the cooling tank component 102. The low-temperature air generated in the cooling tank component 102 can be discharged to the second buffer chamber 20203 of the room temperature water dispensing basin 202, to avoid directly discharging the low-temperature air into the water storage chamber 20201 and affecting the temperature stability of the room temperature water. The second water treatment component can further be the heating tank component 101. The high-temperature air generated in the heating tank component 101 can be discharged to the second buffer chamber 20203 of the room temperature water dispensing basin 202, to avoid directly discharging the high-temperature air into the water storage chamber 20201 and affecting the temperature stability of the room temperature water.

In addition, the second buffer chamber 20203 may be in communication with the water storage chamber 20201, and the low-temperature air generated by the cooling tank component 102 is discharged to the water storage chamber 20201 after being heated in the second buffer chamber 20203. Therefore, the fluid can be prevented from being directly discharged into the water storage chamber 20201 to cause a drastic temperature change of the room temperature water in the water storage chamber 20201. The second buffer chamber 20203 may further be in communication with the outside. Therefore, the low-temperature air generated by the cooling tank component 102 can be discharged to the outside via the second buffer chamber 20203, thereby avoiding frostbite to the user and reducing a risk that external pollutants directly enter into the cooling tank component 102.

Similarly, the high-temperature air generated by the heating tank component 101 may be discharged to the water storage chamber 20201 via the second buffer chamber 20203, and may further be discharged to the outside via the second buffer chamber 20203. As a result, drastic temperature change of the room temperature water can be avoided.

For convenience of understanding, unless otherwise specified, the cooling tank component 102 will be described below as the second water treatment component.

In some embodiments, as shown in FIG. 1 and FIG. 2, the room temperature water dispensing basin 202 includes a basin body 20206 and a second partition 20205. The second partition 20205 is disposed in the basin body 20206, and the basin body 20206 is divided into the water storage chamber 20201 and the second buffer chamber 20203 by the second partition 20205. In an exemplary embodiment of the present disclosure, in combination with the above embodiments, the first buffer chamber 20202 is enclosed by a side of the first partition 20204 and the inner circumferential surface of the basin body 20206, the second buffer chamber 20203 is enclosed by another side of the second partition 20205 and the inner circumferential surface of the basin body 20206, and the water storage chamber 20201 is enclosed by another side of the first partition 20204, another side of the second partition 20205, and the inner circumferential surface of the basin body 20206. That is, the basin body 20206 is divided into the first buffer chamber 20202, the second buffer chamber 20203, and the water storage chamber 20201 by the first partition 20204 and the second partition 20205, thereby improving the integration degree of the room temperature water dispensing basin 202, and achieving the water storage and buffering functions of the room temperature water dispensing basin 202.

Further, as shown in FIG. 1 and FIG. 2, the second partition 20205 extends in an up-down direction. A lower end of the second partition 20205 is connected to a bottom wall of the basin body 20206 to separate the bottom of the water storage chamber 20201 from a bottom of the second buffer chamber 20203. The fluid in the second buffer chamber 20203 may be discharged to the water storage chamber 20201 from a top and/or a side of the second partition 20205, to avoid the fluid directly from being discharged to water storage chamber 20201 resulting in the drastic temperature change of the room temperature water.

Further, a gap is formed between an upper end of the second partition 20205 and a top inner surface of the basin body 20206. That is, the bottom of the second buffer chamber 20203 is separated from the bottom of the water storage chamber 20201, and a top of the second buffer chamber 20203 is in communication with the top of the water storage chamber 20201. As a result, the fluid in the second buffer chamber 20203 is easily discharged to the water storage chamber 20201. The fluid discharged into the second buffer chamber 20203 may be collected at the bottom of the second buffer chamber 20203 first, and then slowly discharged from the top of the second buffer chamber 20203 to the water storage chamber 20201. Therefore, the influence on the temperature of the room temperature water can be avoided.

In addition, in other embodiments of the present disclosure, an upper end of the second partition 20205 is located lower than an upper edge of the basin body 20206. Therefore, the top of the second buffer chamber 20203 is in communication with the top of the water storage chamber 20201, allowing the fluid in the second buffer chamber 20203 to slowly overflow into the water storage chamber 20201. Therefore, the temperature stability of the warm water in the water storage chamber 20201 can be improved.

In combination with the above embodiments, the second water treatment component may be the cooling tank component 102.

In some embodiments, the top of the second partition 20205 is located higher than the water level in the water storage chamber 20201, and is at a second distance L2 from the water level in the water storage chamber 20201. The second distance L2 is greater than or equal to 10 mm. In this way, the room temperature water in the water storage chamber 20201 can be prevented from flowing to the second buffer chamber 20203 to cause the drastic temperature change of the room temperature water. Therefore, fluid discharged from the second water treatment component can be prevented from being affected.

In another exemplary embodiment of the present disclosure, a water level gauge, a float switch, or the like may be disposed in the water storage chamber 20201. In response to detecting that the liquid level in the water storage chamber 20201 reaches a predetermined value, the water source 1001 stops supplying water to the water storage chamber 20201. In this way, after the drinking apparatus 100 is stably mounted, the water level of the room temperature water in the water storage chamber 20201 is located lower than the top of the second partition 20205, thereby avoiding temperature cross-contamination caused by the communication between the room temperature water in the water storage chamber 20201 and the second buffer chamber 20203. Therefore, the second ventilation port 1023 of the second water treatment component can be prevented from being blocked.

In another exemplary embodiment of the present disclosure, the top of the basin body 20206 is open for mounting of the intelligent seat 15. The intelligent seat 15 has an external water inlet and an external air inlet. The water bucket may be placed on the intelligent seat 15. The external water inlet may allow the water storage chamber 20201 to be in communication with the water bucket, and the water flow of the water bucket may supply water to the water storage chamber 20201 from the external water inlet. The external air inlet may allow the water bucket to be in communication with the outside atmosphere to balance the air pressure within the water bucket. After the water level in the water storage chamber 20201 reaches a predetermined water level, the water flow in the water storage chamber 20201 can close the external air inlet to isolate the water bucket from the outside atmosphere and prevent the water tank from continuing to supply water to the water storage chamber 20201. In this way, the water level in the water storage chamber 20201 can be maintained at the predetermined value, and is located lower than the top of the first buffer chamber 20202, thereby avoiding temperature cross-contamination caused by the communication between the water flow in the water storage chamber 20201 and the second buffer chamber 20203. Therefore, the second ventilation port 1023 of the second water treatment component can be prevented from being blocked.

The second distance L2 between the top of the second buffer chamber 20203 and the water level in the water storage chamber 20201 may be 10 mm, 12 mm, 15 mm, etc.

Referring to FIG. 4, the room temperature water dispensing basin 202 is disposed at an upper side of the inlet water manifold 201. The first water treatment component and/or the second water treatment component are disposed at a lower side of the inlet water manifold 201. In an exemplary embodiment of the present disclosure, the room temperature water dispensing basin 202 is disposed at the upper side of the inlet water manifold 201, and the first water treatment component is disposed at the lower side of the inlet water manifold 201. In this way, the drinking apparatus 100 can perform functions such as dispensing water and supplying water under gravity. In an exemplary embodiment of the present disclosure, the room temperature water dispensing basin 202 is located at the upper side of the first water treatment component. Under the action of gravity, water may be supplied from the room temperature water from the room temperature water dispensing basin 202 to the first water treatment component. The water outlet component 8 may be disposed at the inlet water manifold 201. Under the action of gravity, the room temperature water in the room temperature water dispensing basin 202 may be discharged by the inlet water manifold 201. In another embodiment, under the action of gravity, the water level in the room temperature water dispensing basin 202 is located higher than the water level in the first water treatment component. Therefore, hot water or cold water in the first water treatment component can be discharged by the inlet water manifold 201.

Further, the room temperature water dispensing basin 202 and at least part of the inlet water manifold 201 are integrally formed. In this way, the integration degree of the drinking apparatus 100 can be improved, thereby improving the structural strength and operation stability of the drinking apparatus 100.

In some embodiments of the present disclosure, a bottom of the room temperature water dispensing basin 202 is closed by the inlet water manifold 201. That is, the room temperature water dispensing basin 202 and the inlet water manifold 201 do not need to be in communication with each other by a silicone tube, and the room temperature water in the room temperature water dispensing basin 202 can pass through the first inlet 20301 formed at the inlet water manifold 201 to realize water discharge and water supply. Therefore, the operation stability of the drinking apparatus 100 can be greatly improved, and a problem of water leakage caused by aging of the silicone tube can be avoided.

In some embodiments of the present disclosure, a damping plug is disposed in least one of the first exhaust passage 1003 and the second exhaust passage 1004. In an exemplary embodiment of the present disclosure, when the heating tank component 101 exhausts to the first buffer chamber 20202, since an impact of high-temperature vapor is large and a flow velocity is high, the temperature of the room temperature water is easily affected. Therefore, the damping plug may be disposed between the first ventilation port 1013 and the first inlet, and the damping plug has a minute channel. When water vapor passes through the minute channel, the damping plug consumes the energy of the water vapor, thereby reducing a flow velocity and a temperature of the water vapor. In addition, when the discharged liquid of the heating tank component 101 passes through the damping plug, energy will further be lost, thereby reducing the flow velocity and temperature of the discharged liquid, and further avoiding the drastic temperature change of the room temperature water. The damping plug may have a non-return effect to allow the fluid to flow in one direction. In this way, the fluid in the first buffer chamber 20202 can be prevented from flowing back into the heating tank component 101.

In combination with the above embodiments, the first water treatment component may be the heating tank component 101.

Referring to FIG. 15, the first seal 4 is of a ring shape. The first seal 4 has a first sealing groove 403 formed at an end surface of an end of the first seal 4 in an axial direction of the first seal 4. The first sealing groove 403 extends into a ring shape in a circumferential direction of the first seal 4. The water treatment port or an end of the connection tube connected to the water treatment port is inserted into the first sealing groove 403. In this way, a connection of the water treatment port and the connection tube can be sealed in both the radial direction and the axial direction to ensure a sealing effect of the inlet water manifold 201 and the water treatment device 1. The first sealing groove 403 can limit a position of the water treatment port or the connection tube inserted therein, thereby increasing the reliability of an assembly position between the inlet water manifold 201 and the water treatment device 1.

In an exemplary embodiment of the present disclosure, as shown in FIG. 15, the first seal 4 includes a first sealing portion 401 and a second sealing portion 402. The first sealing portion 401 is disposed at an inner side of the peripheral wall of the water treatment port, and the second sealing portion 402 is disposed at an outer side of the peripheral wall of the water treatment port. The first sealing portion 401 and the second sealing portion 402 are connected to each other, and the first sealing groove 403 is defined by the first sealing portion 401 and the second sealing portion 402.

That is, the first seal 4 is disposed at the water treatment port and sleeved over the peripheral wall of the water treatment port. In this way, when the water inlet device 2 or the water outlet device 3 is connected to the water treatment port, the first seal 4 can seal the water inlet device 2 or the water outlet device 3 to prevent water from leaking from the port. In an exemplary embodiment of the present disclosure, after the first seal 4 is sleeved over the water treatment port, a part of the first seal 4 is located at the outer side of the peripheral wall of the water treatment port, and another part of the first seal 4 is located at the inner side of the peripheral wall of the water treatment port. Thus, when the water inlet device 2 or the water outlet component 8 is connected to the water treatment port, the water inlet device 2 or the water outlet component 8 may be in contact with the first seal 4 regardless of whether the water inlet device 2 or the water outlet component 8 is inserted into or sleeved over the water treatment port. Therefore, the first seal 4 can seal the gap between the water treatment port and the water inlet device 2 or water outlet component 8, and thus further provides a predetermined fastening effect.

It can be understood that the first seal 4 may be in a form with a predetermined deformation amount. When the water inlet device 2 or the water outlet component 8 is connected to the water treatment port, the first seal 4 located at the water treatment port may be deformed to improve a sealing effect and connection stability, and separation can be avoided. In some embodiments of the present disclosure, the radial compression amount of at least part of the first seal 4 is greater than or equal to 15% and smaller than or equal to 20%. Therefore, the first seal 4 can be deformed to a certain extent when being subjected to an external pressure to improve the sealing effect. In addition, by controlling the compression amount of the first seal 4, the wear resistance and durability of the seal can further be ensured to ensure that the first seal 4 has good sealing performance and long-term stability.

Similarly, a seal may further be disposed at the second port 3012 to improve the sealing performance and connection stability between the water inlet device 2 or the water outlet component 8 and the second port 3012.

In another exemplary embodiment of the present disclosure, the first seal 4 is an integrally formed structure for ease of manufacturing and assembly. In other embodiments, the first seal 4 is in interference fit with the water treatment port to improve the sealing effect.

In another exemplary embodiment of the present disclosure, the first seal 4 is a silicone member. A compression rebound effect of the silicone member is better, which can better ensure the sealing effect between inlet water manifold 201 and water treatment device 1. Further, the silicone member is nontoxic and odorless, which is more in line with food safety standards.

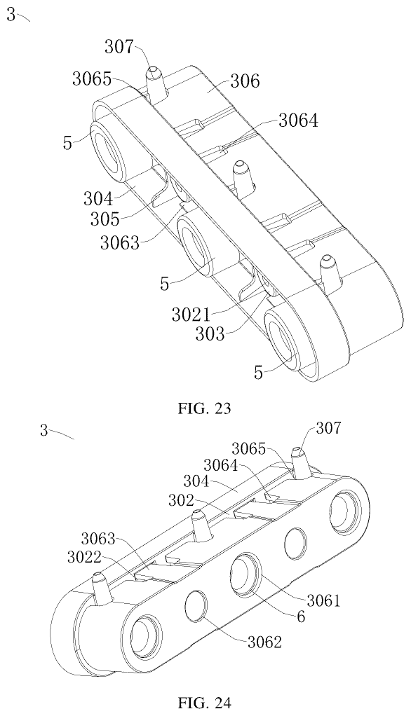

In some embodiments of the present disclosure, as shown in FIG. 23 to FIG. 25, the water outlet device 3 includes a first main body. The first main body includes at least one water outlet connection tube 301. A part of the second flow passageway assembly is formed in the water outlet connection tube 301. The first port 3011 and the second port 3012 are formed at two ends of the water outlet connection tube 301. Thus, water can flow into the water outlet connection tube 301 from one of the first port 3011 and the second port 3012 and flow out of the water outlet connection tube 301 from another one of the first port 3011 and the second port 3012. The water outlet connection tube 301 may extend a water delivery distance, thereby realizing the water delivery when there is a predetermined distance between the water inlet device 2 and the water outlet component 8. Therefore, by providing the water outlet connection tube 301, the water outlet device 3 has fewer requirements on the distance and positional relationship between the water inlet device 2 and the water outlet component 8, thereby facilitating assembly and spatial arrangement.

It should be noted that at least one tubular body portion may be two water outlet connection tubes 301, and may further be three water outlet connection tubes 301 or more. In an exemplary embodiment of the present disclosure, the water outlet component 8 of the drinking apparatus 100 may have two water outlets, i.e., a hot water outlet and a cold water outlet. When the first main body includes two water outlet connection tubes 301, one water outlet connection tube 301 may be connected to the hot water outlet of the water outlet component 8, and another water outlet connection tube 301 may be connected to the cold water outlet of the water outlet component 8. When the drinking apparatus 100 has three water outlets, i.e., the drinking apparatus 100 may also have a room temperature water outlet, three water outlet connection tubes 301 may be provided to be connected to the three water outlets, respectively. Therefore, water at different temperatures circulates in different tubular body portions, which can ensure stable outflowing water temperature, thereby improving an outflowing water effect and functionality of the drinking apparatus 100.

The first main body may include a chamber, and the first port 3011 and the second port 3012 are formed on opposite sides of the chamber. Therefore, water can flow into the chamber from the water inlet device 2 and then flow out from the water outlet component 8. The chamber may deliver a larger amount of water, which can improve an instantaneous water outflow of the drinking apparatus 100.

In another exemplary embodiment of the present disclosure, the first main body may include the tubular body portion and the chamber. For example, in the application, the water outlet connection tube 301 and the chamber may be arranged based on actual conditions. For example, when the water outlet component 8 of the drinking apparatus 100 has the cold water outlet and the hot water outlet, the water outlet connection tube 301 may be disposed at the hot water outlet to control the instantaneous water outflow and avoid scalding the user. The cold water outlet may be formed at the chamber to improve instantaneous water outflowing and water outflow efficiency. The present disclosure is not limited in this regard.

In another exemplary embodiment of the present disclosure, the water outlet connection tube 301 is a tube made of hard material, which can improve the structural stability of the water outlet connection tube 301. A structure of hard material is relatively stable and convenient for mounting, which is convenient for automatic assembly. In combination with the above description, the tube made of the hard material can further avoid peculiar smells and water leakage caused by aging of a tube made of soft material. In addition, the user can regularly clean the tube made of the hard material for recycling, which is beneficial to improving the durability and use feeling of the water outlet device 3.

Further, in some embodiments of the present disclosure, the water outlet connection tube 301 is internally provided with a filter. Therefore, water in the water inlet device 2 can be further filtered by the filter after flowing into the tubular body portion and then flows out of the water outlet component 8. As a result, the quality of the outflowing water can be improved, which is beneficial to improving a use effect of the drinking apparatus 100.

For example, the filter may be disposed in the tube made of the hard material to facilitate assembly of the filter. The filter may be detachably connected to the water outlet connection tube 301. For example, an engagement protrusion is disposed at an inner wall of the water outlet connection tube 301, and the filter is engaged with the engagement protrusion to be fixed to the inner wall of the water outlet connection tube 301. Therefore, the filter is disposed in the water outlet connection tube 301, and water passing through the flow channels can be further filtered by the filter.

In some embodiments of the present disclosure, as shown in FIG. 23 to FIG. 25, the first main body further includes a first plate portion 302. The water outlet connection tube 301 is disposed at the first plate portion 302. The first plate portion 302 is configured to be connected to a main body of the drinking apparatus 100 or the water inlet device 2 of the drinking apparatus 100, to improve the connection stability between the water outlet device 3 and the water inlet device 2, and further improve the connection stability between the first main body and the water inlet device 2. In an exemplary embodiment of the present disclosure, the water outlet connection tube 301 is disposed at the first plate portion 302. When the water outlet connection tube 301 has a predetermined length, the first plate portion 302 can generate a supporting effect on the water outlet connection tube 301, and is beneficial to distributing force. In combination with the above description, two or three water outlet connection tubes 301 may be provided. Therefore, by providing the first plate portion 302, a plurality of water outlet connection tubes 301 can be integrated. When the first plate portion 302 is assembled to the water inlet device 2, the plurality of water outlet connection tubes 301 may be directly connected to the water inlet device 2. Compared with a solution of connecting a plurality of silicone tubes in the related art, the water outlet device 3 according to the embodiments of the present disclosure can connect all the plurality of water outlet connection tubes 301 to the water inlet device 2 and the water outlet component 8, which can improve assembly efficiency.

Further, the first plate portion 302 has a positioning hole for connecting the water inlet device 2 by a connector. The connector may be a fastener, such as a screw. During assembly, the first plate portion 302 may be connected to the water inlet device 2 by passing a fastener through the positioning hole, thereby realizing a connection between the first main body and the water inlet device 2. In an exemplary embodiment of the present disclosure, referring to FIG. 20, a positioning base 20105 is disposed at the water inlet device 2, and the positioning base 20105 is opposite to the positioning hole. The screw passes through the positioning hole and is mounted at the positioning base 20105. In an exemplary embodiment of the present disclosure, referring to FIG. 25, a countersunk structure 303 is disposed at the first plate portion 302, and the positioning hole is formed at the countersunk structure 303. The countersunk structure 303 protrudes towards the water inlet device 2. Therefore, when the screw passes through the positioning hole, a head of the screw may be received in the countersunk structure 303, which is beneficial to improving the structural stability and facilitating a spatial arrangement.

The positioning hole of the first plate portion 302 may further be used to connect the main body of the drinking apparatus 100. For example, when a structure of the water inlet device 2 is not suitable for setting the positioning base 20105, or according to the actual application situation, the first plate portion 302 may further be connected to the main body of the drinking apparatus 100 to improve the stability of the water outlet device 3 after assembly.

In some embodiments, as shown in FIG. 25, the water outlet device 3 further includes a surrounding panel 304 and a reinforcing rib 305. The surrounding panel 304 is connected to a periphery of the first plate portion 302 and arranged around the first plate portion 302. In this way, the structural strength of the first plate portion 302 can be improved. The reinforcing rib 305 is connected to the first plate portion 302 and the surrounding panel 304, which can provide support between the first plate portion 302 and the surrounding panel 304 to further improve the structural strength.

In some embodiments of the present disclosure, as shown in FIG. 20, the inlet water manifold 201 includes a second plate portion 2012. A first connection tube 2013 is disposed at the second plate portion 2012, and is directly connected to the first main body. The water outlet component 8 includes a second connection tube 802 and a valve body 801. The second connection tube 802 is in communication with the valve body 801, and the second connection tube 802 is directly connected to the first main body. That is, the first main body may be connected to the first connection tube 2013 of the water inlet device 2, to deliver water from the second plate portion 2012 to the first main body. The first main body may further be connected to the second connection tube 802 of the water outlet component 8, to discharge water from the first main body via the second connection tube 802 and then out of the valve body 801. Therefore, the stability of the water convey can be improved, and the first main body can be connected to both two components. As a result, it is beneficial to simplifying an assembly structure and improving assembly efficiency.

Referring to FIG. 20, in some embodiments of the present disclosure, the water inlet device 2 includes the second plate portion 2012. The first connection tube 2013 is disposed at the second plate portion 2012, and water in the second plate portion 2012 may be discharged from the first connection tube 2013. The first connection tube 2013 is engaged with the first port 3011 through insertion, to discharge the water in the second plate portion 2012 into the water outlet device 3. During assembly, the first port 3011 and the first connection tube 2013 may directly face towards each other, and then the connection may be completed through insertion, thereby simplifying assembly steps and reducing assembly difficulty. In addition, this assembly method can realize assembly through automatic mechanical assembly, thus improving assembly efficiency.

In some embodiments of the present disclosure, the first connection tube 2013 and at least part of the second plate portion 2012 are integrally formed, which can facilitate manufacturing and improve structural stability. During assembly, the water inlet device 2 may be assembled integrally to facilitate modular assembly of the drinking apparatus 100.

Referring to FIG. 22, in some embodiments of the present disclosure, the water outlet component 8 includes the second connection tube 802 and the valve body 801. The second connection tube 802 is in communication with the valve body 801. In addition, the second connection tube 802 is engaged with the second port 3012 through insertion. Therefore, water in the water outlet device 3 can flow into the second connection tube 802 and then flow out of the valve body 801. During assembly, the second connection tube 802 and the second port 3012 of the water outlet component 8 may be arranged to face towards each other, and then the assembly can be realized through insertion. In this way, it is beneficial to reducing the assembly difficulty and realizing the automatic assembly.

In some embodiments of the present disclosure, the second connection tube 802 and at least part of the valve body 801 are integrally formed, which can facilitate manufacturing and improve structural stability. During assembly, the water outlet component 8 may be assembled integrally to facilitate the modular assembly of the drinking apparatus 100.

In some embodiments of the present disclosure, the water outlet connection tube 301 includes a plurality of water outlet connection tubes 301 arranged side by side and adjacent to each other. The positioning hole and/or the reinforcing rib 305 are arranged between two adjacent water outlet connection tubes 301. Further, the water outlet connection tube 301 and the water outlet port are in one-to-one correspondence and are engaged with each other through insertion. Therefore, a connection between the water inlet device 2 and a first waterway component can be realized simply and quickly.

In an exemplary embodiment of the present disclosure, the water outlet connection tube 301 includes a first water outlet connection tube, a second water outlet connection tube, and a third water outlet connection tube that are sequentially arranged side by side and adjacent to each other. The positioning hole and/or the reinforcing rib 305 are arranged between the first water outlet connection tube and the second water outlet connection tube. The positioning hole and/or the reinforcing rib 305 are arranged between the second water outlet connection tube and the third water outlet connection tube.

Referring to the accompanying drawings, in some embodiments of the present disclosure, the water outlet connection tube 301 includes the first water outlet connection tube and the second water outlet connection tube. The first water outlet connection tube and the second water outlet connection tube are arranged side by side and adjacent to each other, and the positioning hole and/or the reinforcing rib 305 are arranged between the first water outlet connection tube and the second water outlet connection tube. That is, the reinforcing rib 305 may be arranged between the first water outlet connection tube and the second water outlet connection tube. In an exemplary embodiment of the present disclosure, the first water outlet connection tube and the second water outlet connection tube may respectively correspond to two water outlets of the water outlet component 8. Further, there is generally a predetermined spacing between the two water outlets of the water outlet device 3. In this way, a space for the user to receive water can be can provided. Therefore, by arranging a connection structure or the reinforcing rib 305 between the first water outlet connection tube and the second water outlet connection tube, the space can be fully utilized and the structural strength of the water outlet component 8 can be improved. In another embodiment, when both the positioning hole and the reinforcing rib 305 are arranged between the first water outlet connection tube and the second water outlet connection tube, the reinforcing rib 305 can improve the structural stability of a connection between the first plate portion 302 and the water inlet device 2.

Further, the water outlet device 3 may further include the third water outlet connection tube. The first water outlet connection tube, the second water outlet connection tube, and the third water outlet connection tube are arranged side by side at the first plate portion 302. The connection structure or the reinforcing rib 305 is arranged between the first water outlet connection tube and the second water outlet connection tube. The connecting structure or the reinforcing rib 305 is arranged between the second water outlet connection tube and the third water outlet connection tube. In this way, the three water outlet connection tubes can be in communication with the three waterways for conveying water of different temperatures. In addition, the connection structure and/or the reinforcing rib 305 for connecting the water inlet device 2 are arranged between the two connection tubes. Therefore, the connection stability and overall structural stability between the water outlet device 3 and the water inlet device 2 can be improved.

Referring to FIG. 25 and FIG. 26, the second seal 5 of the water inlet device 2 is in a ring shape. The second seal 5 has a second sealing groove 503 formed at an end surface of an end of the second seal 5 in an axial direction of the second seal 5. The second sealing groove 503 extends into a ring shape in a circumferential direction of the second seal 5. The water outlet port or an end of the water outlet connection tube 301 connected to the water outlet port is inserted into the second sealing groove 503.

A connection between the first port 3011 and the first connection tube 2013 can be sealed in both the radial direction and the axial direction to ensure a sealing effect of the water outlet device 3 and the water inlet device 2. The second sealing groove 503 can limit the position of the first port 3011 or the first connection tube 2013 inserted therein, thereby increasing the reliability of an assembly position between the water outlet device 3 and the water inlet device 2.

In an exemplary embodiment of the present disclosure, as shown in FIG. 26, the second seal 5 of the water inlet device 2 includes a third sealing portion 501 and a fourth sealing portion 502. The third sealing portion 501 is disposed at an inner side of a peripheral wall of the first port 3011. The fourth sealing portion 502 is disposed at an outer side of the peripheral wall of the first port 3011. The third sealing portion 501 and the fourth sealing portion 502 are connected to each other, and the second sealing groove 503 is defined by the third sealing portion 501 and the fourth sealing portion 502.

That is, as shown in FIG. 25, the second seal 5 is disposed at the first port 3011 and sleeved over the peripheral wall of the first port 3011. In this way, when the water inlet device 2 or the water outlet device 3 is connected to the first port 3011, the second seal 5 can seal the water inlet device 2 or the water outlet device 3 to prevent water from leaking from the port. In an exemplary embodiment of the present disclosure, after the second seal 5 is sleeved over the first port 3011, a part of the second seal 5 is located at the outer side of the peripheral wall of the first port 3011, and another part of the second seal 5 is located at the inner side of the peripheral wall of the first port 3011. Thus, when the water inlet device 2 is connected to the first port 3011, the water inlet device 2 can be in contact with the second seal 5 regardless of whether the water inlet device 2 extends into the first port 3011 or is sleeved over the first port 301. Therefore, the second seal 5 can seal a gap between the first port 3011 and the water inlet device 2 or the water outlet device 3, and a predetermined fastening effect can be further provided.

The first seal 5 may be in a form with a predetermined deformation amount. When the water inlet device 2 is connected to the first port 3011, the second seal 5 located at the first port 3011 may be deformed to improve the sealing effect and connection stability, and separation can be avoided. In some embodiments of the present disclosure, the radial compression amount of at least part of the second seal 5 is greater than or equal to 15% and smaller than or equal to 20%. Therefore, the second seal 5 can be deformed to a certain extent when being subjected to an external pressure to improve the sealing effect. In addition, by controlling the compression amount of the second seal 5, the wear resistance and durability of the seal can further be ensured to ensure that the second seal 5 has good sealing performance and long-term stability.

In another exemplary embodiment of the present disclosure, the second seal 5 is an integrally formed structure for ease of manufacturing and assembly.

In some embodiments of the present disclosure, the second seal 5 is in interference fit with the first port 3011 to improve the sealing effect.

Further, the second seal 5 is a silicone member. A compression rebound effect of the silicone member is better, which can better ensure the sealing effect between the water inlet device 2 and the water outlet device 3. Further, the silicone member is nontoxic and odorless, which is more in line with food safety standards.

In some embodiments, as shown in FIG. 22, the water outlet component 8 includes a valve body 801 having a third port 803. The third port 803 is engaged with the second port 3012 through insertion. The water outlet component 8 further includes a third tubular body portion disposed at the valve body 801. The third tubular body portion defines the third port 803. Therefore, a connection between the water outlet component 8 and water outlet device 3 can be realized simply and quickly.

Further, the water outlet device 3 includes a third seal 6. At least part of the third seal 6 is disposed between the third port 803 and the second port 3012. A radial compression amount of the at least part of the third seal 6 is greater than or equal to 15% and smaller than or equal to 20%. The third seal 6 is in a ring shape. The third seal 6 has a third seal groove 603 formed at an end surface of an end of the third seal 6 in an axial direction of the third seal 6. The third sealing groove 603 extends into a ring shape in a circumferential direction of the third seal 6. The second port 3012 or the third port 803 is inserted into the third sealing groove 603.

In some embodiments of the present disclosure, as shown in FIG. 27, the water outlet device 3 includes the third seal 6. The third seal 6 includes a fifth sealing portion 601 and a sixth sealing portion 602. The fifth sealing portion 601 is disposed at an inner side of a peripheral wall of the second port 3012. The sixth sealing portion 602 is disposed at an outer side of the peripheral wall of the second port 3012. The fifth sealing portion 601 and the sixth sealing portion 602 are connected to each other, and the third sealing groove 603 is defined by the fifth sealing portion 601 and the sixth sealing portion 602. The third seal 6 may further be configured such that at least part of the third seal 6 has the radial compression greater than or equal to 15% and smaller than or equal to 20%, which can facilitate assembly and has certain sealing performance and stability.

In some embodiments of the present disclosure, as shown in FIG. 24 and FIG. 25, the water outlet device 3 further includes a fixing cover 306. The fixing cover 306 is connected to the first main body, and is configured to position a third seal 6 of the second port 3012. During application, when the water outlet component 8 is connected to the second port 3012, the water outlet component 8 may be repeatedly inserted into the second port 3012. For example, when cleaning or maintenance of the water outlet component 8 is required, such repeated disassembly and mounting of the water outlet component 8 can cause the third seal 6 at the second port 3012 to loosen or fall off. Therefore, the sealing and connection effects cannot be achieved. The third seal 6 is positioned by the fixing cover 306. After mounting, the third seal 6 can be positioned between the second port 3012 and the fixing cover 306, and a position of the third seal 6 is stable, thereby improving an engagement effect between the second port 3012 and the water outlet component 8. In practical application, when the user assembles and disassembles the water outlet component 8, the water outlet device 3 does not need to be reassembled, only the water outlet component 8 and the water outlet device 3 are required to be connected or separated without reassembling water outlet device 3. Therefore, user maintenance is facilitated.

In another exemplary embodiment of the present disclosure, the third seal 6 is an integrally formed structure for ease of manufacturing and assembly.

In some embodiments of the present disclosure, the third seal 6 is in interference fit with the second port 3012 to improve the sealing effect.

Further, in another exemplary embodiment of the present disclosure, the third seal 6 is a silicone member. A compression rebound effect of the silicone member is better, which can better ensure the sealing effect between the water outlet component 8 and the water outlet device 3. Further, the silicone member is nontoxic and odorless, which is more in line with food safety standards.

In some embodiments of the present disclosure, as shown in FIG. 24 and FIG. 25, the fixing cover 306 includes a first sleeve 3061. A peripheral wall of the second port 3012 passes through the first sleeve 3061, and the first sleeve 3061 covers around the peripheral wall of the second port 3012, thereby improving engagement tightness between the fixing cover 306 and the first plate portion 302. The first sleeve 3061 may further be positioned at the third seal 6 of the outer peripheral wall of the second port 3012, or the sixth sealing portion 602 of the third seal 6.

Further, in some embodiments of the present disclosure, the fixing cover 306 further includes a second sleeve 3062. The first main body has a water outlet positioning hole 3021, and the second sleeve 3062 internally has a through groove facing towards the water outlet positioning hole 3021. Therefore, after mounting the fixing cover 306, the fastener may further be inserted through the fixing cover 306 from the second sleeve 3062 to be connected to the water outlet positioning hole 3021 on the first main body, thereby facilitating assembling the first main body to the water inlet device 2. The through groove can further provide a limit effect during the assembly of the fastener, reducing the assembly difficulty. That is, when the drinking apparatus 100 is assembled, the first main body of the water outlet device 3 and the fixing cover 306 may be assembled first, and then the overall structure of the water outlet device 3 is assembled on the water inlet device 2, thereby facilitating the modular production and improving assembly efficiency.

In addition, the second sleeve 3062 may further extend towards the first main body. The second sleeve 3062 may extend to support the first main body when the fixing cover 306 is connected to the first main body, to improve the structural stability of the fixing cover 306 after assembly. In an exemplary embodiment of the present disclosure, the fixing cover 306 has at least one first sleeve 3061, such as two first sleeves 3061 or three first sleeves 3061. The number of the first sleeves 3061 corresponds to the number of the water outlet connection tubes 301. Therefore, the fixing cover 306 can position the third seal 6 at the second port 3012 of each water outlet connection tube 301 after being mounted. The second sleeve 3062 is arranged between the two first sleeves 3061. On one hand, the second sleeve 3062 can be opposite to the water outlet positioning hole 3021 to facilitate assembly, and on the other hand, the second sleeve 3062 between the two first sleeves 3061 can further improve the structural stability of the fixing cover 306.

In other embodiments, the fixing cover 306 may have a through hole facing towards the water outlet positioning hole 3021. Therefore, the first main body can be connected to the water inlet device 2 after the fixing cover 306 is mounted.

In some embodiments, the first plate portion 302 has an engagement slot 3022. The fixing cover 306 is provided with an engagement hook 3063 matching with the engagement slot 3022 in shape. The first plate portion 302 is snapped to the fixing cover 306. In an exemplary embodiment of the present disclosure, the fixing cover 306 may cover the water outlet device 3, and the fixing cover 306 may fix a member between the water outlet device 3 and the fixing cover 306. As a result, the structural stability of the water outlet device 3 is improved, and structural integrity and aesthetics of the water outlet device 3 is further improved.

Further, the fixing cover 306 includes a bottom plate and a side plate. A periphery of the side plate is connected to a periphery of the bottom plate and arranged around the bottom plate. The first sleeve 3061 and the second sleeve 3062 are arranged at the bottom plate. The three first sleeves 3061 are arranged opposite to the three tube bodies and arranged side by side at the bottom plate. The second sleeve 3062 is arranged between two adjacent first sleeves 3061. The engagement hook 3063 is formed at an end of the side plate facing a plate body. The first avoidance notch 3064 is further formed at the side plate, and the first avoidance notch 3064 is located at two opposite sides of the engagement hook 3063, to provide a deformation space for the engagement hook 3063 to be engaged. During assembly, the engagement hook 3063 may extend into the engagement slot 3022 of the first plate portion 302 to achieve engagement, thereby connecting a fixing plate 1302 to the first plate portion 302. The reinforcing rib 305 may further be arranged between two adjacent first sleeves 3061, and the reinforcing rib 305 is connected to the bottom plate and the side plate to improve the structural strength of the fixing cover 306.

Furthermore, a housing-connected positioning post 307 is disposed at an upper side of the first main body. According to the scheme of the embodiments, the housing-connected positioning post 307 is connected to the tubular body portion and extends upwards. A second avoidance notch 3065 is formed at the side plate of the fixing cover 306, and the second avoidance notch 3065 can provide an avoidance space for the housing-connected positioning post 307 when the fixing cover 306 is connected to the water inlet device 2. Therefore, the structural compactness of the water inlet device 2 can be improved. The housing-connected positioning post 307 may be a hollow structure, which can avoid poor injection molding during manufacturing.

In some embodiments, the water outlet connection tube 301 and the third port 803 are in one-to-one correspondence and are engaged with each other through insertion. Therefore, the connection between the water outlet component 8 and the water outlet device 3 can be realized simply and quickly.

In some embodiments, the water outlet component 8 further includes a water outlet tube disposed at the valve body 801. The third port 803 is formed at a water inlet end of the water outlet tube.

In some embodiments of the present disclosure, as shown in FIG. 9, the water outlet component 8 includes a room temperature water outlet member 804, a hot water outlet member 805, and/or a cold water outlet member 806, which can realize room temperature water outflowing, hot water outflowing, and cold water outflowing functions of the drinking apparatus 100.

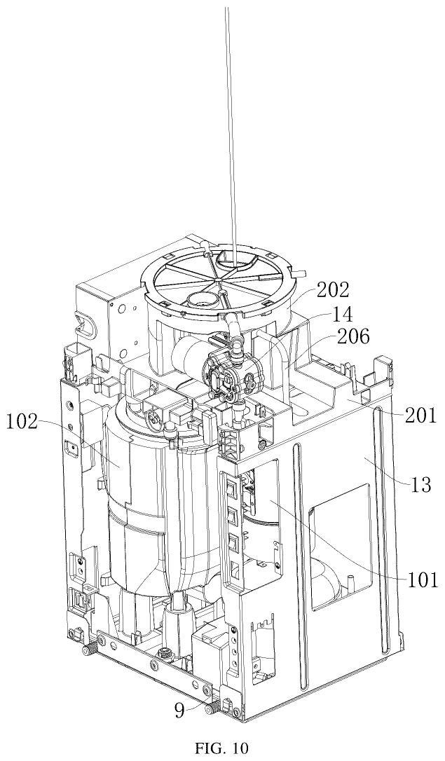

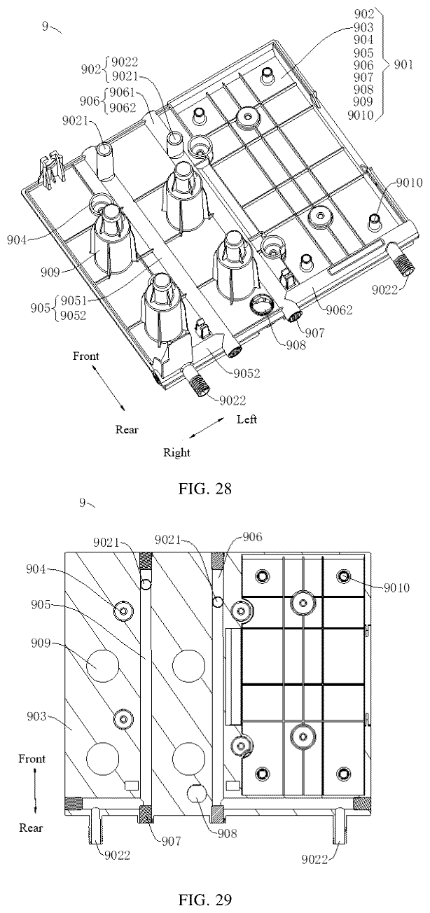

In some embodiments of the present disclosure, as shown in FIG. 10, FIG. 28, and FIG. 29, the drinking apparatus 100 further includes a drainage device 9. The drainage device 9 includes a second main body 901 having at least one drainage flow channel 902. The drainage flow channel 902 has a first drainage port 9021 configured to be connected to the water treatment device 1, and a second drainage port 9022 configured to drain water. The drainage flow channel 902 is configured to guide fluid to flow to the second drainage port 9022 from the first drainage port 9021. Therefore, the drainage device 9 can integrate the flow channels of the drinking apparatus 100, thereby improving the integration degree and reliability of the drinking apparatus 100.

When the drinking apparatus 100 has not been used for a long time, it is necessary to drain the water in the water treatment device 1 to prevent the water in the water treatment device 1 from generating bacterial odor, etc. Therefore, the water treatment device 1 may be connected to the drainage device 9 to realize drainage of the water treatment device 1. The water treatment device 1 is connected to the drainage device 9 via the first drainage port 9021. The water flow can be discharged out of the water treatment device 1 via the first drainage port 9021, and flow along the flow channels in the drainage device 9. By being guided by the flow channels, the water flow may pass through the second drainage port 9022 to realize the drainage of water treatment device 1.

In addition, at least one drainage flow channel 902 is provided, and is integrated on the second main body 901. During assembly, the water tank component may be mounted at the drainage device 9. Therefore, the interior of the water treatment device 1 may be in communication with the flow channels of the drainage device 9, facilitating the drainage of the water treatment device 1, and improving assembly efficiency. The drainage device 9 may be mounted at the housing 13 of the drinking apparatus 100, thereby improving the reliability of the drinking apparatus 100.

In some embodiments, the second main body 901 includes a plate body portion 903 and at least one tubular body portion. The at least one tubular body portion is disposed at the plate body portion 903 and extends along the plate body portion 903. A drainage flow channel 902 is formed in the tubular body portion. In an exemplary embodiment of the present disclosure, the plate body portion 903 may be mounted at the housing 13 of the drinking apparatus 100 to improve the operation stability of the drainage device 9. The plate body portion 903 has a plurality of first drainage positioning holes 904. The housing 13 of the drinking apparatus 100 has a plurality of second drainage positioning holes. The plurality of first drainage positioning holes 904 and the plurality of second drainage positioning holes are in one-to-one correspondence and are connected to each other through the fastener, thereby realizing mounting of the drainage device 9 at the housing 13 of the drinking apparatus 100. The tubular body portion is disposed at the plate body portion 903. The drainage flow channel 902 is defined in the tubular body portion. The first drainage port 9021 and the second drainage port 9022 are formed at a tube wall of the tubular body portion. The first drainage port 9021 may be connected to the water treatment device 1 to drain the water flow in the water treatment device 1. As a result, bacterial contamination can be prevented from being generated in the drinking apparatus 100 for a long time.

In addition, the tubular body portion may extend in an extending direction of the plate body portion 903, and thus an appearance of the second main body 901 is neat. Therefore, interference with an internal structure of the drinking apparatus 100 is reduced, and the integration degree of the drinking apparatus 100 is improved.

In some embodiments of the present disclosure, the at least one tubular body portion includes a first tubular body 905. The first tubular body 905 is disposed at the plate body portion 903 and extends along the plate body portion 903. The first tubular body 905 has a first drainage port 9021 configured to be connected to a second water treatment component, and a second drainage port 9022 configured to drain water from the second water treatment component. In an exemplary embodiment of the present disclosure, in combination with the above exemplary examples, the second water treatment component may be the cooling tank component 102, and the cooling tank component 102 may be connected to the drainage device 9 via the first drainage port 9021 of the first tubular body 905. When drainage is required, the water flow in the cooling tank component 102 may be discharged via the first drainage port 9021 and flow along the flow channels in the first tubular body 905. By being guided by the flow channels, the water flow can be discharged via the second drainage port 9022 of the first tubular body 905 to realize the drainage of the cooling tank component 102.

Further, as shown in FIG. 28 and FIG. 29, the first tubular body 905 includes a first tube section 9051 and a second tube section 9052. The first tube section 9051 extends in a width direction of the plate body portion 903, and the first drainage port 9021 of the first tubular body 905 is formed at an end of the first tube section 9051. The second tube section 9052 is connected to another end of the first tube section 9051 and extends in a length direction of the plate body portion 903. The second drainage port 9022 of the first tubular body 905 is formed at the second tube section 9052. It can be understood that, in the first tubular body 905, the first drainage port 9021 and the second drainage port 9022 are respectively located at two sides of the first tubular body 905 in the width direction. In practice, the first drainage port 9021 may be located adjacent to a front side of the drinking apparatus 100, and the second drainage port 9022 may be located adjacent to a rear side of the drinking apparatus 100. In this way, the drinking apparatus 100 can be opened from the front side of the drinking apparatus 100 during maintenance of the drinking apparatus 100. The second drainage port 9022 may be hidden behind the drinking apparatus 100 to ensure a clean appearance of the drinking apparatus 100 and improve user experience.

In addition, due to a heat exchange requirement of the drinking apparatus 100, a heat exchanger 10 is generally mounted at the rear side of the drinking apparatus 100. Therefore, the second tube section 9052 of the first tubular body 905 may extend in the length direction of the plate body portion 903 to allow the second drainage port 9022 to avoid the heat exchanger 10 and avoid structural interference. The second tube section 9052 of the first tubular body 905 may extend in the length direction to further avoid other structural members.

In some embodiments of the present disclosure, the at least one tubular body portion further includes a second tubular body 906. The second tubular body 906 is disposed at the plate body portion 903 and extends along the plate body portion 903. The second tubular body 906 has a first drainage port 9021 configured to be connected to a first water treatment component and a second drainage port 9022 configured to drain water from the first water treatment component. In an exemplary embodiment of the present disclosure, in combination with the above embodiments, the first water treatment component may be the heat tank component 101, and the heat tank component 101 may be connected to the drainage device 9 via the first drainage port 9021 of the second tubular body 906. When drainage is required, the water flow in the heating tank component 101 may be discharged via the second drainage port 9022 and flow along the flow channels in the second tubular body 906. By being guided by the flow channels, the water flow can be discharged via the second drainage port 9022 of the second tubular body 906 to realize the drainage of the heating tank component 101.

In some exemplary examples, a three-way pipe is disposed in the drinking apparatus 100, and the three-way pipe is connected to the room temperature water dispensing basin 202, the heating tank component 101, and the second drainage port 9022 of the second tubular body 906, respectively. When drainage is required, synchronous drainage of the room temperature water dispensing basin 202 and the heating tank component 101 can be realized, thereby improving drainage efficiency. In addition, the room temperature water dispensing basin 202 and the heating tank component 101 drain water via the second tubular body 906, and the cooling tank component 102 drains water via the first tubular body 905. As a result, temperature cross-contamination between the heating tank component 101 and the cooling tank component 102 can be effectively avoided.

Further, as shown in FIG. 28 and FIG. 29, the second tubular body 906 includes a third tube section 9061 and a fourth tube section 9062. The third tube section 9061 extends in a width direction of the plate body portion 903. The first drainage port 9021 of the second tubular body 906 is formed at an end of the third tube section 9061. The fourth tube section 9062 is connected to another end of the third tube section 9061 and extends in a length direction of the plate body portion 903. The second drainage port 9022 of the second tubular body 906 is formed at the fourth tube section 9062. It can be understood that, in the second tubular body 906, the first drainage port 9021 and the second drainage port 9022 are respectively located at two sides of the second tubular body 906 in the width direction. In practice, the first drainage port 9021 may be located adjacent to the front side of the drinking apparatus 100, and the second drainage port 9022 can be located adjacent to the rear side of the drinking apparatus 100. In this way, the drinking apparatus 100 can be opened from the front side of the drinking apparatus 100 during maintenance of the drinking apparatus 100. The second drainage port 9022 may be hidden behind the drinking apparatus 100 to ensure the clean appearance of the drinking apparatus 100 and improve user experience.

In addition, due to the heat exchange requirement of the drinking apparatus 100, the heat exchanger 10 is generally mounted at the rear side of the drinking apparatus 100. Therefore, the second tube section 9052 of the second tubular body 906 may extend in the length direction of the plate body portion 903 to allow the second drainage port 9022 to avoid the heat exchanger 10 and avoid structural interference. The second tube section 9052 of the second tubular body 906 may extend in the length direction to further avoid other structural members.

In some embodiments, the fourth tube section 9062 extends away from the first tubular body 905, allowing an avoidance space to be formed between the first tubular body 905 and the second tubular body 906. The avoidance space may be used for assembling structures in the drinking apparatus 100. Further, the second drainage port 9022 of the second tubular body 906 may be formed at an end of the fourth tube section 9062 away from the first tubular body 905, and the second drainage port 9022 of the first tubular body 905 may be formed at an end of the second tube section 9052 away from the second tubular body 906. In this way, the avoidance space between the first tubular body 905 and the second tubular body 906 can be further increased. Referring to the accompanying drawings, the avoidance space may be used to avoid the heat exchanger 10 in the drinking apparatus 100.

In another exemplary embodiment of the present disclosure, the tubular body portion is molded through an injection molding process and has a mold release hole. The mold release hole is closed by a blocking element 907. In this way, it is convenient to process the tubular body portion. During the injection molding, a complex tubular body portion may be processed by processing a tube section extending in the width direction and a tube section extending in the length direction, and the mold release hole may be closed by the blocking element 907 after the processing is completed. As a result, the processing cost can be lowered, and the production efficiency can be improved.

In other embodiments, the tubular body portion and the plate body portion 903 are integrally formed. The tubular body portion and the plate body portion 903 may be integrally molded to improve the structural strength of the drainage device 9, thereby improving the operation stability of the drinking apparatus 100.

In some embodiments, the second main body 901 includes a first main body part and a second main body part. The first main body part is provided with a first positioning structure 909 configured for mounting of the water treatment device 1, and the second main body part is provided with a second positioning structure 9010 configured for mounting of a compressor 11. As a result, connection strength between the drainage device 9 and the water treatment device 1 and the compressor 11 can be enhanced, and the operation stability of the drinking apparatus 100 can be improved.

In an exemplary embodiment of the present disclosure, taking the embodiment of FIG. 28 and FIG. 29 as an example, the first positioning structure 909 may include a plurality of positioning posts, and a plurality of positioning grooves is arranged at a bottom of the cooling tank component 102. The plurality of positioning posts may be correspondingly embedded into the plurality of positioning grooves to limit and support the cooling tank component 102, thereby improving the operation stability of the drinking apparatus 100. Taking the embodiment of FIG. 28 and FIG. 29 as an example, the second positioning structure 9010 has a plurality of first connection holes, and the compressor 11 has a plurality of second connection holes. The plurality of first connection holes and the plurality of second connection holes are in one-to-one correspondence and are connected to each other by the fastener. Therefore, the operation stability of the drinking apparatus 100 can be improved.

Further, the first drainage port 9021 is formed at the first main body part. In combination with the above embodiments, the water treatment device 1 may include the room temperature water dispensing basin 202, the heating tank component 101, and the cooling tank component 102. The room temperature water dispensing basin 202, the heating tank component 101, and the cooling tank component 102 are arranged at the first main body part of the second main body 901. The room temperature water dispensing basin 202, the heating tank component 101, and the cooling tank component 102 may be respectively connected to the drainage device 9 by the corresponding first drainage port 9021. Other functional members such as the compressor 11 may be mounted at the second main body part, thereby facilitating the assembly of the water treatment device 1 and the drainage device 9, and improving the production efficiency.

In some embodiments, the drainage device 9 further includes a fourth seal. The fourth seal is sleeved over and engaged with the first drainage port 9021 and the connection tube of the water treatment device 1, respectively. A radial compression amount of the fourth seal is greater than or equal to 10% and smaller than or equal to 15%.

Such arrangement facilitates disassembly and assembly between the drainage device 9 and the water treatment device 1.

In another exemplary embodiment of the present disclosure, the water treatment device 1 may have the connection tube, and the first drainage port 9021 may have the connection tube. The fourth seal can be sleeved over the connection tube of the first drainage port 9021 and the connection tube of the water treatment device 1, respectively, to seal a gap between the first drainage port 9021 and the water treatment device 1 and improve the sealing performance of the drinking apparatus 100. The radial compression amount of the fourth seal is greater than or equal to 10% and smaller than or equal to 15%. Therefore, a service life of the fourth seal can be prolonged while meeting the sealing performance requirements. In addition, through an engagement between the fourth seal and the connection tube of the first drainage port 9021 and an engagement between the fourth seal and the connection tube of the water treatment device 1, rapid disassembly and assembly of the water treatment device 1 and the drainage device 9 can be realized. The fourth seal may be a sealed silicone connector, and a radial compression of a silicone plug may be 12%.

The radial compression amount of the fourth seal may be 10%, 11%, 14%, 15%, etc.

In some embodiments of the present disclosure, the first drainage port 9021 is constructed into a tubular shape extending in a thickness direction of the second main body 901. In an exemplary embodiment of the present disclosure, in combination with the above embodiments, the drainage device 9 is connected to the water treatment device 1 by the fourth seal. Therefore, by constructing the first drainage port 9021 into a tubular shape extending in the thickness direction of the second main body 901, a connection between the first drainage port 9021 of the drainage device 9 and the water treatment device 1 is facilitated, thereby improving the connection stability.

In other embodiments, the second drainage port 9022 is constructed into a tubular shape extending in a direction perpendicular to the thickness direction of the second main body 901. Such an arrangement facilitates a connection between the second drainage port 9022 and the silicone tube for releasing the drainage water.

In some embodiments of the present disclosure, the drainage device 9 further includes an openable or closable member configured to close the second drainage port 9022 in an openable manner. Therefore, a drainage function of the water treatment device 1 can be realized by the openable or closable member. In practice, the water tank component 101 is arranged above the drainage device 9. Under the action of gravity, the water flow in the water treatment device 1 fills the drainage flow channel 902 of the drainage device 9. When drainage is required, the second drainage port 9022 can be opened by the openable or closable member to realize the drainage. When drainage is not required, the second drainage port 9022 can be closed by the openable or closable member.

In some embodiments, as shown in FIG. 28, the second drainage port 9022 is provided with threads at a peripheral wall of the second drainage port 9022, and the openable or closable member is configured to be connected to the second drainage port 9022 through a threaded connection to open or close the second drainage port 9022. That is, the openable or closable member may be connected to the peripheral wall of the second drainage port 9022 through a threaded connection. The second drainage port 9022 may be opened or closed by rotating the openable or closable member. In this way, the second drainage port 9022 can be prevented from being opened, which would cause water leakage of the drinking apparatus 100, when the openable or closable member is subjected to an external impact. In addition, the second drainage port 9022 can be prevented from being opened due to mistake, which would cause scalding of infants.

In some embodiments of the present disclosure, the water treatment device 1 includes a first water treatment component and/or a second water treatment component. The first water treatment component is a heating tank component 101, and the second water treatment component is a cooling tank component 102. That is, the water flow in the room temperature water dispensing basin 202 may flow to the heating tank component 101 and/or the cooling tank component 102, and be heated by the heating tank component 101 and refrigerated by the cooling tank component 102. The water outlet device 3 may include the room temperature water outlet member 804, the hot water outlet member 805, and/or the cold water outlet member 806. The water flow in the room temperature water dispensing basin 202 is discharged via the room temperature water outlet member 804 after flowing through the water inlet device 2. In another embodiment, the water flow in the room temperature water dispensing basin 202 is discharged via the hot water outlet member 805 after flowing through the hot water tank component 101. In further another embodiment, the water flow in the room temperature water dispensing basin 202 is discharged via the cold water outlet member 806 after flowing through the cooling tank component 102.

In some embodiments, the second main body 901 has a drainage avoidance hole 908 extending through opposite sides of the second main body 901 in the thickness direction. The drainage avoidance hole 908 may be used to allow pipes of the drainage avoidance hole 908 to pass therethrough, allowing the water bucket at a side of the drainage device 9 to be connected to the water treatment device 1 at another side of the drainage device 9.

In some exemplary examples of the present disclosure, the second main body 901 has a plurality of wiring harness positioning portions configured to position the wiring harness inside the water dispenser. Therefore, the cleanliness of an interior of the water dispenser is improved, and interference between the wiring harness and the structural members is avoided.

In some exemplary examples of the present disclosure, the second main body 901 has a shielding portion located at a vertical edge of the second main body 901 in the thickness direction. The shielding portion is configured to shield the structural members, the wiring harnesses, and the like arranged at the drainage device 9, thereby avoiding exposing the interior of the water dispenser to the outside and affecting a normal operation of the water dispenser.

In some exemplary examples of the present disclosure, the second main body 901 has a third positioning structure. The third positioning structure may be located at the vertical edge of the second main body 901 in the thickness direction and disposed adjacent to the first drainage port 9021. The third positioning structure may be configured to position a gate control switch. When a door body of the water dispenser is opened, the gate control switch may be triggered, and the gate control switch may transmit signals with an electronic control component, to control functional members in the water dispenser to stop operating, thereby preventing the functional members from being jeopardized when a technician maintains the water dispenser.

The drainage device 9 may be formed into one piece using food-grade PP injection molding with high hygiene and safety.

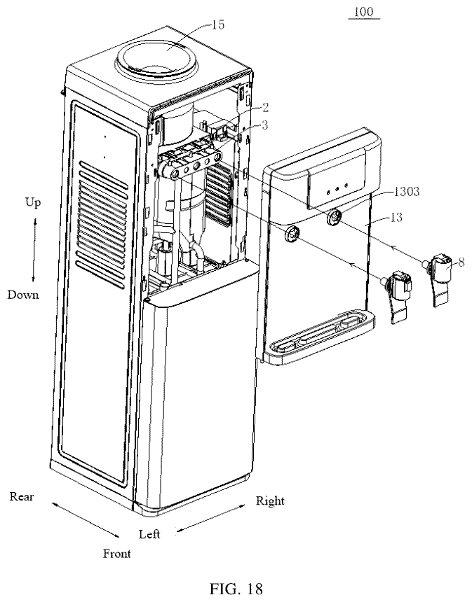

Referring to FIG. 18 to FIG. 22, in some embodiments of the present disclosure, the drinking apparatus 100 further includes the housing 13 connected to the water outlet component 8. The housing 13 has a limit hole 1301. The housing-connected positioning post 307 is disposed at the water outlet device 3, and extends through the limit hole 1301. In an exemplary embodiment of the present disclosure, the housing 13 may cover the water inlet device 2 to improve the aesthetics of the drinking apparatus 100. A part of the water outlet component 8 is located at an outer side of the housing 13 and is connected to the housing 13, which can improve the mounting stability of the water outlet component 8 and achieve a purpose of the user receiving water outside the drinking apparatus 100. A side of the water outlet component 8 is connected to the water outlet device 3. To improve the structural stability and assembly accuracy, when the housing 13 is mounted, the limit hole 1301 may face towards the housing positioning post 307. Therefore, the housing positioning post 307 passes through the limit hole 1301, thereby achieving positioning and limiting effects, and improving structure stability among the water outlet component 8, the water outlet device 3, and the housing 13. A mounting position of the housing 13 is conveniently positioned accurately during assembly, which is beneficial to improving assembly efficiency.

Referring to FIG. 18 to FIG. 22, in an exemplary embodiment of the present disclosure, the fixing plate 1302 is connected to an inner wall of the housing 13, and is perpendicular to the inner wall of the housing 13. A plurality of limit holes 1301 is formed at the fixing plate 1302. Each of a plurality of tubular body portions has the housing-connected positioning post 307 disposed at an outer wall of the tubular body portion. The housing-connected positioning post 307 extends in an up-down direction of the drinking apparatus 100. During assembly, the housing 13 is assembled from up to down in the up-down direction of the drinking apparatus 100. The housing positioning post 307 may pass through the limit hole 1301 during mounting. The housing 13 further has a mounting hole 1303, and the water outlet component 8 passes through the mounting hole 1303 in a front-rear direction and is connected to the water outlet device 3. In conjunction with FIG. 18, the number of mounting holes 1303 may match with the number of water outlet components 8. Referring to FIG. 20, the number of water outlet connection tubes 301 may match with the number of water outlet components 8, or the number of water outlet connection tubes 301 may be greater than the number of water outlet components 8. For example, the drinking apparatus 100 may include only the cold water outlet member 806 or the room temperature water outlet member 804 and the hot water outlet member 805, or may include the cold water outlet member 806, the room temperature water outlet member 804, and the hot water outlet member 805. Regardless of whether two water outlet components 8 or three water outlet components 8 are arranged at the drinking apparatus 100, the same water outlet device 3 may be arranged in the drinking apparatus 100, which can improve the versatility of the water outlet device 3.

A waterway system 1000 of the drinking apparatus 100 according to the embodiments of the present disclosure will be described below with reference to FIG. 32 to FIG. 36.

As shown in FIG. 32, the waterway system 1000 of the drinking apparatus 100 according to the embodiment of the present disclosure includes a room temperature water dispensing basin 2, a heating tank component 101, a cooling tank component 102, and a water outlet device 3.

In an exemplary embodiment of the present disclosure, the room temperature water dispensing basin 202 is in communication with the water source 1001. Further, the room temperature water dispensing basin 202 is connected to the second flow passageway 204, the fourth flow passageway 209, and the first flow passageway 203. Two ends of the second flow passageway 204 are respectively connected to and are in communication with the heating tank component 101 and the room temperature water dispensing basin 202. The heating tank component 101 is connected to the third flow passageway 205. Two ends of the fourth flow passageway 209 are respectively connected to and are in communication with the cooling tank component 102 and the room temperature water dispensing basin 2. The cooling tank component 102 is connected to the fifth flow passageway 2010. Two ends of the third flow passageway 205 are respectively connected to and are in communication with the heating tank component 101 and the water outlet device 3. Two ends of the fifth flow passageway 2010 are respectively connected to and are in communication with the cooling tank component 102 and the water outlet device 3. Two ends of the first flow passageway 203 are respectively connected to and are in communication with the room temperature water dispensing basin 2 and the water outlet device 3. Thus, a configuration of the waterway system 1000 is simple, and the user experience is improved.

In the related art, for water outflowing of the room temperature water of the drinking apparatus 100, room temperature water is usually discharged from an upper part of a cooling tank. An interior of the cooling tank is divided into the upper part and a lower part by a plastic flow diverting plate, and the upper part and the lower part are in communication with each other. After barreled water of the drinking apparatus 100 flows into the cooling tank, the outflowing water from the upper part of the cooling tank is the room temperature water, and cold water is discharged from a bottom of the lower part of the cooling tank. This traditional design may have issues in which when the room temperature water is not taken for a long time, the outflowing water of first few cups of the room temperature water will be cold. Since the room temperature water is not taken for a long time, the cooling tank will refrigerate all the water in the cooling tank to a same predetermined low temperature. In addition, since a volume of a room temperature water storage area in the industry is small, there will be obvious flow attenuation and flow interruption problems when taking the room temperature water for a long time. The water flows into the heating tank through a room temperature water region at the upper part of the cooling tank, passes through a central tube of the plastic flow diverting plate inside the cooling tank, and then flows into the heating tank. Therefore, the water flowing into the heating tank will further be cold, reducing heating efficiency and increasing energy consumption.

According to the waterway system 1000 of the drinking apparatus 100 of the embodiments of the present disclosure, by arranging the room temperature water dispensing basin 2 independently of the cooling tank component 102 and the heating tank component 101, it is ensured that the temperature of the room temperature water is neither too cold nor too hot, and the temperature is always consistent with the room temperature. In addition, a stable outflow of the room temperature water for a long time is further ensured, avoiding the flow attenuation and the flow interruption of the room temperature water.

Further, when the drinking apparatus 100 is in operation, the room temperature water dispensing basin 202 is in communication with the water source 1001. As drinking water flows into the room temperature water dispensing basin 202, a part of the drinking water flows to the heating tank component 101 via the second flow passageway 204, a part of the drinking water flows to the cooling tank component 102 via the fourth flow passageway 209, and a part of the drinking water is stored in the room temperature water dispensing basin 202. When the user needs hot water, hot water in the heating tank component 101 flows out of the drinking apparatus 100 via the third flow passageway 205 by means of the water outlet device 3. When the user needs cold water, cold water in the cooling tank component 102 flows out of the drinking apparatus 100 via the fifth flow passageway 2010 by means of the water outlet device 3. When the user needs room temperature water, room temperature water in the room temperature water dispensing basin 202 flows out of the drinking apparatus 100 via the first flow passageway 203 by means of the water outlet device 3.

For the above example, it should be explained that the room temperature water in the room temperature water dispensing basin 202, the hot water in the heating tank component 101, and the cold water in the cooling tank component 102 are merely examples and are not limitations on the present disclosure. That is, a liquid in one state in the room temperature water dispensing basin 202 is delivered to two containers with different liquid treatment heating via the second flow passageway 204 and the fourth flow passageway 209, respectively, to bring the liquid in the room temperature water dispensing basin 202 into other states. Therefore, it can be understood that when the waterway system 1000 does not have the heating tank component 101 and the cooling tank component 102, the water in the room temperature water dispensing basin 2 may further flow out via the first flow passageway 203 by means of the water outlet device 3, and the water in the room temperature water dispensing basin 2 may only flow into other water treatment devices 1 via the inlet flow channel to change the state of the water. For example, the temperature of the water may be changed. A form of water may also be changed, which may be from a liquid state to a gas state. The present disclosure is not limited in this regard, and detailed description thereof will not be described in the following examples.

In some embodiments of the present disclosure, as shown in FIG. 32 to FIG. 36, the first inlet 20301 is formed at a first end of the second flow passageway 204, and the second outlet 20401 is formed at a second end of the second flow passageway 204. The first inlet 20301 is configured to be connected to the room temperature water dispensing basin 202, and the second outlet 20401 is configured to be connected to the heating tank component 101. The fourth inlet 20901 is formed at a first end of the fourth flow passageway 209, and the fourth outlet 20902 is formed at a second end of the fourth flow passageway 209. The fourth inlet 20901 is configured to be connected to the room temperature water dispensing basin 202, and the fourth outlet 20902 is configured to be connected to the cooling tank component 102. It can be understood that the first end of the second flow passageway 204 is connected to the room temperature water dispensing basin 2, and the second end of the second flow passageway 204 is connected to the heating tank component 101. The second flow passageway 204 is in communication with the room temperature water dispensing basin 2 via the first inlet 20301, and the second flow passageway 204 is in communication with the heating tank component 101 via the second outlet 20401. The first end of the fourth flow passageway 209 is connected to the room temperature water dispensing basin 202, and the second end of the fourth flow passageway 209 is connected to the cooling tank component 102. The fourth flow passageway 209 is in communication with the room temperature water dispensing basin 202 via the fourth inlet 20901, and the fourth flow passageway 209 is in communication with the cooling tank component 102 via the fourth outlet 20902. Therefore, by arranging two independent inlet flow passageways, water can be provided to two different treatment links for heating and refrigerating respectively from the same source as desired, thereby ensuring flexibility and efficiency of temperature regulation of the waterway system 1000.

In some embodiments of the present disclosure, as shown in FIG. 32 to FIG. 36, a third inlet 20501 is formed at a first end of the third flow passageway 205, and the third outlet 20502 is formed at a second end of the third flow passageway 205. The third inlet 20501 is configured to be connected to the heating tank component 101, and the third outlet 20502 is configured to be connected to the water outlet device 3. A fifth inlet 201001 is formed at a first end of the fifth flow passageway 2010, and a fifth outlet 201002 is formed at a second end of the fifth flow passageway 2010. The fifth inlet 201001 is configured to be connected to the cooling tank component 102, and the fifth outlet 201002 is configured to be connected to the water outlet device 3. It can be understood that the first end of the third flow passageway 205 is connected to the heating tank component 101, and the second end of the third flow passageway 205 is connected to the water outlet device 3. The third flow passageway 205 is in communication with the heating tank component 101 via the third inlet 20501. Further, the third flow passageway 205 is in communication with the water outlet device 3 via the third outlet 20502. The first end of the fifth flow passageway 2010 is connected to the cooling tank component 102, and the second end of the fifth flow passageway 2010 is connected to the water outlet device 3. The fifth flow passageway 2010 is in communication with the cooling tank component 102 via the third inlet 20501. Further, the fifth flow passageway 2010 is in communication with the water outlet device 3 via the third outlet 20502. Therefore, both heated water and refrigerated water may be collected into the same water outlet device 3 via their respective outlet flow passageways, and may be mixed and adjusted to a desired temperature, or used separately based on demand. therefore, the efficiency and flexibility of the waterway system 1000 in water temperature management and dispensing can be reflected.

In an exemplary embodiment of the present disclosure, in combination with the above embodiments, the waterway system 1000 of the drinking apparatus 100 of this example includes at least three waterways. The three waterways can output the room temperature water, the hot water, and the cold water, respectively. The first end of the second flow passageway 204 is connected to the room temperature water dispensing basin 2, and the second end of the second flow passageway 204 is connected to the heating tank component 101. The second flow passageway 204 is in communication with the room temperature water dispensing basin 2 via the first inlet 20301. Further, the second flow passageway 204 is in communication with the heating tank component 101 via the second outlet 20401. The first end of the third flow passageway 205 is connected to the heating tank component 101, and the second end of the third flow passageway 205 is connected to the water outlet device 3. The third flow passageway 205 is in communication with the heating tank component 101 via the third inlet 20501. Further, the third flow passageway 205 is in communication with the water outlet device 3 via the third outlet 20502. The first end of the fourth flow passageway 209 is connected to the room temperature water dispensing basin 202, and the second end of the fourth flow passageway 209 is connected to the cooling tank component 102. The fourth flow passageway 209 is in communication with the room temperature water dispensing basin 202 via the fourth inlet 20901. Further, the fourth flow passageway 209 is in communication with the cooling tank component 102 via the fourth outlet 20902. The first end of the fifth flow passageway 2010 is connected to the cooling tank component 102, and the second end of the fifth flow passageway 2010 is connected to the water outlet device 3. The fifth flow passageway 2010 is in communication with the cooling tank component 102 via the third inlet 20501. Further, the fifth flow passageway 2010 is in communication with the water outlet device 3 via the third outlet 20502. A first end of the first flow passageway 203 is connected to the room temperature water dispensing basin 2, and a second end of the first flow passageway 203 is connected to the water outlet device 3. The first flow passageway 203 is in communication with the room temperature water dispensing basin 2 via the first inlet 20301. Further, the first flow passageway 203 is in communication with the water outlet device 3 via the first outlet 20302.

In short, the room temperature water flows into the heating tank component 101 from the room temperature water dispensing basin 2 via the second flow passageway 204 and flows into the cooling tank component 102 via the fourth flow passageway 209. Room temperature water after being heated by the heating tank component 101 flows out via the third flow passageway 205 by means of the water outlet device 3, and/or room temperature water after being refrigerated by the cooling tank component 102 flows out via the fifth flow passageway 2010 by means of the water outlet device 3, and/or room temperature water in the room temperature water dispensing basin 202 flows out via the third inlet flow passageway by means of the water outlet device 3.

It should be noted here that, as shown in FIG. 32 to FIG. 36, the first inlet 20301 of the first flow passageway 203 and the first inlet 20301 of the second flow passageway 204 are actually located at a same position as the through hole.

In some embodiments of the present disclosure, as shown in FIG. 32 to FIG. 36, the heating tank component 101 is connected to the first exhaust passage 1003. The first air inlet 20602 is formed at a first end of the first exhaust passage 1003, and the first exhaust vent 20601 is formed at a second end of the first exhaust passage 1003. The first air inlet 20602 is configured to be connected to the heating tank component 101, and the first exhaust vent 20601 is configured to be in communication with the atmosphere to balance the air pressure within the heating tank component 101. The cooling tank component 102 is connected to the second exhaust passage 1004. The second air inlet 20801 is formed at a first end of the second exhaust passage 1004, and the second exhaust vent 20802 is formed at a second end of the second exhaust passage 1004. The second air inlet 20801 is configured to be connected to the cooling tank component 102, and the second exhaust vent 20802 is configured to be in communication with the atmosphere to balance the air pressure within the cooling tank component 102. That is, the first exhaust passage 1003 and the second exhaust passage 1004 are provided to ensure the stability of the pressure in the heating tank component 101 and the cooling tank component 102. The first end of the first exhaust passage 1003 is connected to the heating tank component 101, and the second end of the first exhaust passage 1003 is in communication with the atmosphere. The first exhaust passage 1003 is in communication with the heating tank component 101 via the first air inlet 20602. By arranging the exhaust passages reasonably, the safety and effectiveness of the whole waterway system 1000 can be ensured.

In an exemplary embodiment of the present disclosure, the first air inlet 20602 is configured to collect water vapor and other gases generated due to an increased water temperature in the heating tank. The air flows to the first exhaust vent 20601 via the first exhaust passage 1003, and the air is exhausted to the atmosphere from the first exhaust vent 20601, thereby reducing the pressure in the heating tank component 101 and preventing the safety and system efficiency from being affected by the excessive pressure. The second air inlet 20801 is configured to collect air generated by temperature change or liquid volume change. The air flows to the second exhaust vent 20802 via the second exhaust passage 1004, and is exhausted to the atmosphere from the second exhaust vent 20802, thereby adjusting the pressure in the cooling tank component 102 to avoid a negative pressure or excessive air pressure in the cooling tank component 102. As a result, normal operation of the cooling tank component 102 can be ensured.

In some embodiments of the present disclosure, as shown in FIG. 32 to FIG. 36, the room temperature water dispensing basin 2 internally has a first partition 20204. The first partition 20204 is configured to divide the room temperature water dispensing basin 2 into the first buffer chamber 20202. The second end of the first exhaust passage 1003 is in communication with the first buffer chamber 20202. The room temperature water dispensing basin 2 internally has a second partition 20205. The second partition 20205 is configured to divide the room temperature water dispensing basin 2 into the second buffer chamber 20203. The second end of the second exhaust passage 1004 is in communication with the second buffer chamber 20203. It can be understood that the air in the heating tank component 101 may flow into the first buffer chamber 20202 when flowing out of the first exhaust passage 1003, and the first buffer chamber 20202 is divided by the first partition 20204. As a result, an influence of the air exhausted from the heating tank component 101 on the temperature of the room temperature water in the room temperature water dispensing basin 202 can be reduced. The air in the cooling tank component 102 may flow into the second buffer chamber 20203 when flowing out of the second exhaust passage 1004, and the second buffer chamber 20203 is divided by the second partition 20205. As a result, an influence of the air exhausted from the cooling tank component 102 on the temperature of the room temperature water in the room temperature water dispensing basin 202 can be reduced. In addition, compared with a case where the air is discharged directly to the outside, discharging the air into an exhaust region of the room temperature water dispensing basin 2 can effectively prevent the external environment from polluting the interior of the heating tank component 101 and/or the cooling tank component 102.

In some embodiments of the present disclosure, as shown in FIG. 32, the room temperature water dispensing basin 2 is connected to a main water inlet flow passageway 1002. A main water inlet is formed at a first end of the main water inlet flow passageway 1002. A main water outlet is formed at a second end of the main water inlet flow passageway 1002. The main water inlet is configured to be connected to the water source 1001, and the main water outlet is configured to be connected to the room temperature water dispensing basin 2. The first end of the main water inlet flow passageway 1002 is connected to the water source 1001, and the second end of the main water inlet flow passageway 1002 is connected to the room temperature water dispensing basin 202. The room temperature water dispensing basin 202 is in communication with the main water inlet flow passageway 1002 via the main water inlet and the main water outlet. Thus, the efficiency and controllability of the entire waterway system 1000 are ensured, and the reliability of the waterway system 1000 is improved.

In an exemplary embodiment of the present disclosure, in combination with the above embodiments, the liquid flowing into the room temperature water dispensing basin 2 from the water source 1001 via the main water inlet flow passageway 1002 is the room temperature water. The room temperature water from the room temperature water dispensing basin 2 flows into the heating tank component 101 via the second flow passageway 204 and flows into the cooling tank component 102 via the fourth flow passageway 209 as desired. The room temperature water after being heated by the heating tank component 101 flows out via the third flow passageway 205 by means of the water outlet device 3, and/or room temperature water after being refrigerated by the cooling tank component 102 flows out via the fifth flow passageway 2010 by means of the water outlet device 3, and/or room temperature water in the room temperature water dispensing basin 202 flows out via the third inlet flow passageway by means of the water outlet device 3. The first exhaust passage 1003 regulates the pressure in the heating tank component 101, and the second exhaust passage 1004 regulates the pressure in the cooling tank component 102.

It should be noted here that the water source 1001 may be water from a drinking water bucket connected to the main water inlet, or water from a tap connected to the main water inlet for supplying water.

In some embodiments of the present disclosure, as shown in FIG. 32 to FIG. 36, the heating tank component 101 is connected to a first drainage flow passageway 1005. A first end of the first drainage flow passageway 1005 is in communication with the second flow passageway 204 to discharge wastewater in the room temperature water dispensing basin 2 and/or wastewater in the heating tank component 101. The cooling tank component 102 is connected to a second drainage flow passageway 1006. A first end of the second drainage flow passageway 1006 is in communication with the cooling tank component 102 to discharge wastewater in the cooling tank component 102. That is, the heating tank component 101 and the room temperature water dispensing basin 2 share the first drainage flow passageway 1005. Therefore, a structural composition of the waterway system 1000 is simplified, and freshness of the water quality and treatment efficiency in the heating tank component 101 and the room temperature water dispensing basin 2 can be maintained. An effective discharge of the wastewater is crucial to prevent impurity accumulation, control microbial growth, and maintain overall sanitation of the system. In addition, a proper drainage design can further help adjust a water balance in the waterway system 1000 to ensure that all parts can operate efficiently within design parameters.

In some embodiments of the present disclosure, the waterway system 1000 of the drinking apparatus 100 further includes the inlet water manifold 201. As shown in FIG. 1 to FIG. 9, the inlet water manifold 201 and the room temperature water dispensing basin 202 are integrally formed. Then, by integrally forming the inlet water manifold 201 and the room temperature water dispensing basin 2, a mounting process of the waterway system 1000 is simplified, and assembly steps and time are reduced. Therefore, the maintenance and overhaul is more convenient and quicker, the structural stability and pressure resistance of the waterway system 1000 is improved, and a service life of the waterway system 1000 is effectively prolonged. Additionally, the integrated design is conducive to a compact layout, which can save a mounting space.

In some embodiments of the present disclosure, the inlet water manifold 201 has a main water inlet tube, a first water inlet tube, and a second water inlet tube. The main water inlet flow passageway 1002 of the waterway system 1000 is formed in the main water inlet tube. The second flow passageway 204 of the waterway system 1000 is formed in the first water inlet tube. The fourth flow passageway 209 of the waterway system 1000 is formed in the second water inlet tube. It can be understood that two ends of the main water inlet tube are respectively connected to the water source 1001 and the room temperature water dispensing basin 202. Two ends of the first water inlet tube are respectively connected to the room temperature water dispensing basin 202 and the heating tank component 101. Two ends of the second water inlet tube are respectively connected to the room temperature water dispensing basin 202 and the cooling tank component 102.

In other embodiments, as shown in FIG. 1 to FIG. 9 and FIG. 32 to FIG. 36, the main water inlet flow passageway 1002, the second flow passageway 204, and the fourth flow passageway 209 of the waterway system 1000 are all integrated at the inlet water manifold 201.

When the room temperature water dispensing basin 202 is connected to the water source 1001, the room temperature water dispensing basin 202 may be in communication with the main water inlet of the main water inlet flow passageway 1002 to introduce water flow into the room temperature water dispensing basin 202. When the heating tank component 101 is mounted at the inlet water manifold 201, the heating tank component 101 may be in communication with the second flow passageway 204 to introduce the room temperature water from the room temperature water dispensing basin 2 into the heating tank component 101. When the cooling tank component 102 is mounted at the inlet water manifold 201, the cooling tank component 102 may be in communication with the fourth flow passageway 209 to introduce the room temperature water from the room temperature water dispensing basin 2 into the cooling tank component 102.

In some embodiments of the present disclosure, the inlet water manifold 201 further has a first water outlet tube, a second water outlet tube, and a third water outlet tube. The third flow passageway 205 of the waterway system 1000 is formed in the first water outlet tube. The fifth flow passageway 2010 of the waterway system 1000 is formed in the second water outlet tube. The first flow passageway 203 of the waterway system 1000 is formed in the third water outlet tube. It can be understood that two ends of the first water outlet tube are respectively connected to the heating tank component 101 and the water outlet device 3. Two ends of the second water outlet tube are respectively connected to the cooling tank component 102 and the water outlet device 3. Two ends of the third water outlet tube are respectively connected to the room temperature water dispensing basin 202 and the water outlet device 3.

In other embodiments, as shown in FIG. 1 to FIG. 9 and FIG. 32 to FIG. 36, the third flow passageway 205, the fifth flow passageway 2010, and the first flow passageway 203 of the waterway system 1000 are all integrated at the inlet water manifold 201. When hot water is taken, the hot water flows out from the heating tank component 101 via the third flow passageway 205 by means of the water outlet device 3. When cold water is taken, the cold water flows out from the cooling tank component 102 via the fifth flow passageway 2010 by means of the water outlet device 3. When room temperature water is taken, the room temperature water flows out from the room temperature water dispensing basin 2 via the first flow passageway 203 by means of the water outlet device 3.

In some embodiments of the present disclosure, the inlet water manifold 201 further has the first exhaust tube 206 and the second exhaust tube 208. The first exhaust passage 1003 of the waterway system 1000 is formed in the first exhaust tube 206. The second exhaust passage 1004 of the waterway system 1000 is formed in the second exhaust tube 208. It can be understood that two ends of the first exhaust tube 206 are respectively connected to the heating tank component 101 and the atmosphere, and two ends of the second exhaust tube 208 are respectively connected to the cooling tank component 102 and the atmosphere.

In other embodiments, as shown in FIG. 1 to FIG. 9 and FIG. 32 to FIG. 36, the first exhaust passage 1003 and the second exhaust passage 1004 of the waterway system 1000 are both integrated at the inlet water manifold 201. When the heating tank component 101 is mounted at the inlet water manifold 201, the heating tank component 101 may be in communication with the first exhaust passage 1003 to exhaust the air in the heating tank component 101 to the atmosphere, thereby balancing the air pressure within the heating tank component 101. When the cooling tank component 102 is mounted at the inlet water manifold 201, the cooling tank component 102 may be in communication with the second exhaust passage 1004 to exhaust the air in the cooling tank component 102 to the atmosphere, thereby balancing the air pressure in the cooling tank component 102.

In an exemplary embodiment of the present disclosure, in combination with the above embodiments, the room temperature water dispensing basin 2 is configured to store the room temperature water introduced via the main water inlet flow passageway 1002. When the room temperature water dispensing basin 2 supplies water to the heating tank component 101 via the second flow passageway 204, the heating tank component 101 exhausts the air in the heating tank component 101 to the first buffer chamber 20202 via the first exhaust passage 1003, to maintain the balance of the air pressure within the heating tank component 101. When the room temperature water dispensing basin 2 supplies water to the cooling tank component 102 via the fourth flow passageway 209, the cooling tank component 102 exhausts the air in the cooling tank component 102 to the second buffer chamber 20203 via the second exhaust passage 1004, to maintain the balance of the air pressure within the cooling tank component 102.

The waterway system 1000 of the drinking apparatus 100 according to two exemplary embodiments of the present disclosure will be described below with reference to FIG. 1 to FIG. 9 and FIG. 32 to FIG. 36.

### First Embodiment

Referring to FIG. 1 to FIG. 9 and FIG. 32 to FIG. 36, the waterway system 1000 includes the room temperature water dispensing basin 2, the heating tank component 101, and the cooling tank component 102, which are arranged independently of each other.

In an exemplary embodiment of the present disclosure, the first end of the main water inlet flow passageway 1002 is connected to the water source 1001, and the second end of the main water inlet flow passageway 1002 is connected to the room temperature water dispensing basin 2. The room temperature water dispensing basin 2 is in communication with the main water inlet flow passageway 1002 via the main water inlet and the main water outlet. The first end of the second flow passageway 204 is connected to the room temperature water dispensing basin 202, and the second end of the second flow passageway 204 is connected to the heating tank component 101. The second flow passageway 204 is in communication with the room temperature water dispensing basin 202 via the first inlet 20301. Further, the second flow passageway 204 is in communication with the heating tank component 101 via the second outlet 20401. The first end of the fourth flow passageway 209 is connected to the room temperature water dispensing basin 202, and the second end of the fourth flow passageway 209 is connected to the cooling tank component 102. The fourth flow passageway 209 is in communication with the room temperature water dispensing basin 202 via the fourth inlet 20901. Further, the fourth flow passageway 209 is in communication with the cooling tank component 102 via the fourth outlet 20902.

The first end of the third flow passageway 205 is connected to the heating tank component 101, and the second end of the third flow passageway 205 is connected to the water outlet device 3. The third flow passageway 205 is in communication with the heating tank component 101 via the third inlet 20501. Further, the third flow passageway 205 is in communication with the water outlet device 3 via the third outlet 20502. The first end of the fifth flow passageway 2010 is connected to the cooling tank component 102, and the second end of the fifth flow passageway 2010 is connected to the water outlet device 3. The fifth flow passageway 2010 is in communication with the cooling tank component 102 via the third inlet 20501. Further, the fifth flow passageway 2010 is in communication with the water outlet device 3 via the third outlet 20502. The first end of the first flow passageway 203 is connected to the room temperature water dispensing basin 2, and the second end of the first flow passageway 203 is connected to the water outlet device 3. The first flow passageway 203 is in communication with the room temperature water dispensing basin 2 via the first inlet 20301. Further, the first flow passageway 203 is in communication with the water outlet device 3 via the first outlet 20302.

That is, the room temperature water flows into the heating tank component 101 from the room temperature water dispensing basin 2 via the second flow passageway 204, and flows into the cooling tank component 102 via the fourth flow passageway 209. The room temperature water after being heated by the heating tank component 101 flows out via the third flow passageway 205 by means of the water outlet device 3, and/or room temperature water after being refrigerated by the cooling tank component 102 flows out via the fifth flow passageway 2010 by means of the water outlet device 3, and/or room temperature water in the room temperature water dispensing basin 202 flows out via the third inlet flow passageway by means of the water outlet device 3.

The first air inlet 20602 is configured to collect water vapor and other gases generated due to an increased water temperature in the heating tank. The air flows to the first exhaust vent 20601 via the first exhaust passage 1003, and is exhausted to the atmosphere from the first exhaust vent 20601, thereby reducing the pressure within the heating tank component 101 and preventing the safety and system efficiency from being affected by excessive pressure. The second air inlet 20801 is configured to collect air generated by temperature change or liquid volume change. The air flows to the second exhaust vent 20802 via the second exhaust passage 1004, and is exhausted to the atmosphere from the second exhaust vent 20802. As a result, the pressure in the cooling tank component 102 is adjusted to avoid a negative pressure or excessive air pressure in the cooling tank component 102. Therefore, the normal operation of the cooling tank component 102 can be ensured.

The heating tank component 101 and the room temperature water dispensing basin 2 share the first drainage flow passageway 1005. The cooling tank component 102 is connected to a second drainage flow passageway 1006. The first end of the second drainage flow passageway 1006 is in communication with the cooling tank component 102 to discharge wastewater in the cooling tank component 102.

The inlet water manifold 201 and the room temperature water dispensing basin 202 are integrally formed. The main water inlet flow passageway 1002, the second flow passageway 204, and the fourth flow passageway 209 are all integrated at the inlet water manifold 201. The third flow passageway 205, the fifth flow passageway 2010, and the first flow passageway 203 of the waterway system 1000 are all integrated at the inlet water manifold 201. The first exhaust passage 1003 and the second exhaust passage 1004 of the waterway system 1000 are both integrated at the inlet water manifold 201.

### Second Embodiment

A structure of this embodiment is substantially the same as a structure of the first embodiment. Same reference numerals are used for same members, and the only difference lies in the following description. In the first embodiment, the main water inlet flow passageway 1002, the second flow passageway 204, and the fourth flow passageway 209 are all integrated at the inlet water manifold 201, the third flow passageway 205, the fifth flow passageway 2010, and the first flow passageway 203 of the waterway system 1000 are all integrated at the inlet water manifold 201, and the first exhaust passage 1003 and the second exhaust passage 1004 of the waterway system 1000 are both integrated at the inlet water manifold 201. In the second embodiment, the inlet water manifold 201 has the main water inlet tube, the first water inlet tube, the second water inlet tube, the first water outlet tube, the second water outlet tube, the third water outlet tube, the first exhaust tube 206, and the second exhaust tube 208. Further, the main water inlet flow passageway 1002 of the waterway system 1000 is formed in the main inlet tube. The second flow passageway 204 of the waterway system 1000 is formed in the first inlet tube. The fourth flow passageway 209 of the waterway system 1000 is formed in the second inlet tube. The third flow passageway 205 of the waterway system 1000 is formed in the first outlet tube. The fifth flow passageway 2010 of the waterway system 1000 is formed in the second outlet tube. The first flow passageway 203 of the waterway system 1000 is formed in the third water outlet tube. The first exhaust passage 1003 of the waterway system 1000 is formed in the first exhaust tube 206. The second exhaust passage 1004 of the waterway system 1000 is formed in the second exhaust tube 208.

Operating principles of the waterway system 1000 of the drinking apparatus 100 will be described below.

The water source 1001 flows through the main water inlet, the main water inlet flow path 1002, and the main water outlet sequentially, and then flows into the room temperature water dispensing basin 202 to form the room temperature water.

For the outflowing of the room temperature water from the drinking apparatus 100, the room temperature water in the room temperature water dispensing basin 2 flows through the first inlet 20301, the first flow passageway 203, and the first outlet 20302 sequentially, and finally flows to the room temperature water outlet member 804 of the water outlet device 3, thereby realizing the outflowing of the room temperature water.

For the outflowing of the hot water from the drinking apparatus 100, the room temperature water in the room temperature water dispensing basin 2 flows into the heating tank component 101 through the first inlet 20301, the second flow passageway 204, and the second outlet 20401 sequentially, and then flows through the third inlet 20501, the third flow passageway 205, and the third outlet 20502 sequentially after being heated by the heating tank component 101. Finally, the water flows to the hot water outlet member 805 of the water outlet device 3, thereby realizing the outflowing of the hot water. In addition, during a process of introducing the room temperature water into the heating tank component 101, the heating tank component 101 exhausts the air in the heating tank component 101 to the first buffer chamber 20202 via the first exhaust passage 1003 to maintain the balance of the air pressure within the heating tank component 101.

For the outflowing of the cold water from the drinking apparatus 100, the room temperature water in the room temperature water dispensing basin 202 flows into the cooling tank component 102 through the fourth inlet 20901, the fourth flow passageway 209, and the fourth outlet 20902 sequentially, and then flows through the fifth inlet 201001, the fifth flow passageway 2010 and the fifth outlet 201002 sequentially after being refrigerated by the cooling tank component 102. Finally, the water flows to the cold water outlet member 806 of the water outlet device 3, thereby realizing the outflowing of the cold water. In addition, during a process of introducing the room temperature water into the cooling tank component 102, the cooling tank component 102 exhausts the air in the cooling tank component 102 to the second buffer chamber 20203 via the second exhaust passage 1004 to maintain the balance of the air pressure within the cooling tank component 102.

The drinking apparatus 100 according to the embodiments of the present disclosure includes the waterway system 1000 according to the drinking apparatus 100 of the above embodiments of the present disclosure.

According to the drinking apparatus 100 of the embodiments of the present disclosure, as shown in FIG. 1 to FIG. 36, by arranging the waterway system 1000 of the drinking apparatus 100 of the above embodiments, the room temperature water dispensing basin 2 is arranged independently of the cooling tank component 102 and the heating tank component 101. Therefore, the room temperature water and the cold water are not in a same storage container, and the room temperature water and the hot water are not in a same storage container. In this way, it can be ensured that the temperature of the room temperature water is neither too cold nor too hot, and the temperature can be kept to be consistent with the room temperature all the time. Further, it can be ensured the stable outflow of the room temperature water for a long time, and the flow attenuation and flow interruption of the room temperature water for a long time can be avoided. In addition, a water supplement of the cooling tank component 102 and a water supplement of the heating tank component 101 are both implemented by the room temperature water in the room temperature water dispensing basin 2. In this way, the water flowing into the heating tank component 101 and the cooling tank component 102 is ensured to be the room temperature water, thereby reducing the temperature cross-contamination in the waterway system 1000 of the drinking apparatus 100, and reducing the energy consumption for heating of the heating tank component 101 and the energy consumption for refrigerating of the cooling tank component 102.

In the description of the present disclosure, it should be understood that the orientation or position relationship indicated by the terms “center”, “upper”, “lower”, “vertical”, “horizontal”, “top”, “bottom”, “inner”, “outer”, “axial”, “radial”, “circumferential”, etc., is based on the orientation or position relationship shown in the drawings, and is only for the convenience of describing the present disclosure and simplifying the description, rather than indicating or implying that the pointed apparatus or element must have a specific orientation, or be constructed and operated in a specific orientation, and therefore cannot be understood as a limitation on the present disclosure.

In addition, terms “first” and “second” are only used for descriptive purposes, and cannot be understood as indicating or implying relative importance or implicitly indicating the number of the indicated technical features. Therefore, the features associated with “first” and “second” may explicitly or implicitly include at least one of the features. In the description of the present disclosure, “plurality” means at least two, unless otherwise specifically defined.

In the present disclosure, unless otherwise clearly specified and limited, terms such as “install”, “connect”, “connect to”, “fix” and the like should be understood in a broad sense. For example, it may be a fixed connection or a detachable connection or connection as one piece; direct connection or indirect connection through an intermediate; internal communication of two components or the interaction relationship between two components, unless otherwise clearly limited. For those skilled in the art, the specific meaning of the above-mentioned terms in the present disclosure can be understood according to specific circumstances.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

In descriptions of the present disclosure, descriptions with reference to the terms “an embodiment”, “some embodiments”, “examples”, “specific examples”, or “some examples” etc., mean that specific features, structure, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. Further, different embodiments or examples and features of different embodiments or examples described in this specification may be combined and combined by one skilled in the art without contradiction.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. A drinking apparatus, comprising:
a water treatment device;
a water inlet device;
a water outlet device, wherein:
the water inlet device has a water source port, a water treatment port, a water outlet port, and a first flow passageway assembly, the water source port being configured to be connected to a water source, the water treatment port being configured to be connected to the water treatment device, the water outlet port being configured to be connected to the water outlet device, the water source port, the water treatment port, and the water outlet port being connected by the first flow passageway assembly, and the first flow passageway assembly being configured to guide water from the water source to flow to the water treatment device and the water outlet device; and
the water outlet device has a second flow passageway assembly, a first port, and a second port, one of the first port and the second port being configured to be connected to the water inlet device, another one of the first port and the second port being configured to be connected to a water outlet component, and the first port and the second port being in communication with each other via the second flow passageway assembly.

2. The drinking apparatus according to claim 1, wherein the water inlet device comprises:
an inlet water manifold, the water source port, the water treatment port, the water outlet port, and the first flow passageway assembly being all formed at the inlet water manifold; and
a room temperature water dispensing basin connected to the inlet water manifold and in communication with the water source port.

3. The drinking apparatus according to claim 2, wherein the first flow passageway assembly includes:
a first flow passageway having a first inlet and a first outlet; and
a second flow passageway having a second inlet and a second outlet, wherein:
the first inlet and the second inlet are configured as the water source port;
the second outlet is configured as the water treatment port and to supply water to a first water treatment component; and
the first outlet is configured as the water outlet port and to discharge the water from the water source out of the drinking apparatus.

4. The drinking apparatus according to claim 3, wherein the second inlet is in communication with the first flow passageway.

5. The drinking apparatus according to claim 3, wherein the first flow passageway assembly further comprises a third flow passageway,
wherein the third flow passageway has a third inlet and a third outlet, the third inlet being configured as the water treatment port and to receive water treated by the first water treatment component, and the third outlet being configured as the water outlet port and to discharge the water treated by the first water treatment component out of the drinking apparatus.

6. The drinking apparatus according to claim 5, wherein the water inlet device further has a first exhaust passage formed at the inlet water manifold,
wherein the first exhaust passage has a first air inlet configured to be connected to the first water treatment component, and a first exhaust vent configured to be in communication with an atmosphere to balance an air pressure within the first water treatment component.

7. The drinking apparatus according to claim 6, wherein the water inlet device further comprises a first exhaust tube extending through the inlet water manifold, wherein:
the first exhaust passage is formed in the first exhaust tube; or
the first exhaust passage is integrated at the inlet water manifold.

8. The drinking apparatus according to claim 6, wherein the first exhaust vent of the first exhaust passage is in communication with an internal space of the room temperature water dispensing basin.

9. The drinking apparatus according to claim 2, wherein the water inlet device further has a second exhaust passage formed at the inlet water manifold,
wherein the second exhaust passage has a second air inlet configured to be connected to a second water treatment component, and a second exhaust vent configured to be in communication with an atmosphere to balance an air pressure within the second water treatment component.

10. The drinking apparatus according to claim 6, wherein:
the room temperature water dispensing basin has a first buffer chamber; and
the first water treatment component has a first water port, a second water port, and a first ventilation port, wherein:
the first water port is connected to the second outlet and is in communication with the water storage chamber via the second flow passageway to supply water to the first water treatment component;
the second water port is connected to the third inlet and is in communication with the third outlet via the third flow passageway to discharge the water treated by the first water treatment component out of the drinking apparatus; and
the first ventilation port is connected to the first air inlet and is in communication with the first buffer chamber via the first exhaust passage to balance the air pressure within the first water treatment component.

11. The drinking apparatus according to claim 10, wherein the room temperature water dispensing basin comprises:
a basin body; and
a first partition disposed in the basin body, the basin body being divided into a water storage chamber and the first buffer chamber by the first partition.

12. The drinking apparatus according to claim 11, wherein:
the first partition extends in an up-down direction; and
the first partition has a lower end connected to a bottom wall of the basin body.

13. The drinking apparatus according to claim 11, wherein:
the first partition has a flow return opening, the water storage chamber and the first buffer chamber being in communication with each other via the flow return opening; or
a gap between the first partition and a peripheral wall of the basin body is formed as a flow return opening, the water storage chamber and the first buffer chamber being in communication with each other via the flow return opening.

14. The drinking apparatus according to claim 13, wherein a width dimension D of the flow return opening in a circumferential direction of the basin body is greater than or equal to 0.5 mm and smaller than or equal to 1.5 mm.

15. The drinking apparatus according to claim 10, wherein the first exhaust vent is formed in the first buffer chamber, and is located higher than a bottom inner surface of the first buffer chamber.

16. The drinking apparatus according to claim 10, wherein a top of the first buffer chamber is located higher than a water level in the water storage chamber, and is at a first distance L1 from the water level in the water storage chamber, the first distance L1 being greater than or equal to 10 mm.

17. The drinking apparatus according to claim 9, wherein:
the room temperature water dispensing basin has a second buffer chamber;
the second water treatment component has a third water port, a fourth water port, and a second ventilation port, wherein:
the third water port is connected to the fourth outlet and is in communication with the water storage chamber via a fourth flow passageway to supply water to the second water treatment component;
the fourth water port is connected to the fifth inlet and is in communication with the fifth outlet via a fifth flow passageway to discharge the water treated by the second water treatment component out of the drinking apparatus; and
the second ventilation port is connected to the second air inlet and is in communication with the second buffer chamber via the second exhaust passage to balance the air pressure within the second water treatment component.

18. The drinking apparatus according to claim 17, wherein the room temperature water dispensing basin comprises:
a basin body; and
a second partition disposed in the basin body, the basin body being divided into a water storage chamber and the second buffer chamber by the second partition.

19. The drinking apparatus according to claim 17, wherein a top of the second partition is located higher than a water level in the water storage chamber, and is at a second distance L2 from the water level in the water storage chamber, the second distance L2 being greater than or equal to 10 mm.

20. The drinking apparatus according to claim 1, wherein the water outlet component comprises a room temperature water outlet member, a hot water outlet member, and/or a cold water outlet member.
